(19) United States
(12) Patent Application Publication
(10) Pub. No.: US 2025/0313680 A1
(43) Pub. Date: Oct. 9, 2025

(54) TIRE RUBBER COMPOSITIONS COMBINING BAGASSE-CONTAINING GUAYULE RUBBER WITH SILANE AND RELATED METHODS

(71) Applicant: Bridgestone Corporation, Chuo-ku (JP)

(72) Inventors: Mark N. DeDecker, North Canton, OH (US); Hyeonjae S. Kim, Copley, OH (US)

(73) Assignee: Bridgestone Corporation, Chuo-ku (JP)

(21) Appl. No.: 19/241,444

(22) Filed: Jun. 18, 2025

Related U.S. Application Data
(63) Continuation of application No. 18/257,822, filed on Jun. 15, 2023.
(60) Provisional application No. 63/127,534, filed on Dec. 18, 2020.

(51) Int. Cl. C08K 5/5415; B60C 1/00; C08K 3/04; C08K 5/548; C08L 19/00

(52) U.S. Cl. CPC C08K 5/5415; B60C 1/0016; B60C 1/0025; B60C 1/0041; C08K 3/04; C08K 5/548; C08L 19/00; B60C 2001/0066; B60C 2200/06; C08K 2201/019

(57) ABSTRACT

Disclosed herein are methods for improving the rolling resistance of a tire rubber composition by providing a rubber composition including a rubber component which includes a majority by weight of guayule rubber where the guayule rubber includes a bagasse component, and a filler component where the filler component is free of silica, and including at least one silane in the rubber composition, where the at least one silane is selected from the group consisting of mercaptosilanes, blocked mercaptosilanes, and alkoxysilanes. Also disclosed is a tire rubber composition which comprises (a) 100 parts of a rubber component including a majority by weight of guayule rubber where the guayule rubber includes a bagasse component, (b) a filler component, where the filler component is free of silica, and (c) at least one silane selected from the group consisting of mercaptosilanes, blocked mercaptosilanes, and alkoxysilanes.

### CROSS REFERENCE TO RELATED APPLICATIONS

This application is a continuation of U.S. application Ser. No. 18/257,822, filed Jun. 15, 2023, which is a U.S. national stage of International Application Number PCT/US2021/072972 filed on Dec. 16, 2021, which claims priority to U.S. provisional application Ser. No. 63/127,534, filed Dec. 18, 2020, all of which are hereby incorporated by reference in their entirety.

### FIELD

The present application is directed to a tire rubber composition which combines bagasse-containing guayule rubber with silane in the absence of silica filler and to related methods of reducing the rolling resistance of a tire rubber composition.

### BACKGROUND

The guayule plant (Parthenium argentatum) is a woody shrub-like plant that contains rubber within the cells of the plant. Processes which are directed to isolating rubber from the guayule plant require isolation of the rubber from the woody material (which is referred to as bagasse). The presence of bagasse in the guayule rubber can be detrimental to the properties of the rubber composition, especially when the rubber composition is used in a tire (e.g., in a tread rubber composition).

### SUMMARY

Disclosed herein is a tire rubber composition which includes as a rubber component a majority by weight of guayule rubber which includes a bagasse component, a filler component that is free of silica, and at least one silane. Also disclosed is a method for improving the rolling resistance of a tire rubber composition by providing a rubber composition which includes as a rubber component a majority by weight of guayule rubber which includes a bagasse component, a filler component that is free of silica, and at least one silane.

In a first embodiment, a method for improving the rolling resistance of a tire rubber composition is provided. The method comprises providing a rubber composition including a rubber component which includes a majority by weight of guayule rubber where the guayule rubber includes a bagasse component, and a filler component where the filler component is free of silica, by including at least one silane in the rubber composition, where the at least one silane is selected from the group consisting of mercaptosilanes, blocked mercaptosilanes, and alkoxysilanes.

In a second embodiment, a tire rubber composition is provided. The tire rubber composition comprises (a) 100 parts of a rubber component including a majority by weight of guayule rubber where the guayule rubber includes a bagasse component, (b) a filler component, where the filler component is free of silica, and (c) at least one silane selected from the group consisting of mercaptosilanes, blocked mercaptosilanes, and alkoxysilanes.

### DETAILED DESCRIPTION

Disclosed herein is a tire rubber composition which includes as a rubber component a majority by weight of guayule rubber which includes a bagasse component, a filler component that is free of silica, and at least one silane. Also disclosed is a method for improving the rolling resistance of a tire rubber composition by providing a rubber composition which includes as a rubber component a majority by weight of guayule rubber which includes a bagasse component, a filler component that is free of silica, and at least one silane.

In a first embodiment, a method for improving the rolling resistance of a tire rubber composition is provided. The method comprises providing a rubber composition including a rubber component which incudes a majority by weight of guayule rubber where the guayule rubber includes a bagasse component, and a filler component where the filler component is free of silica, by including at least one silane in the rubber composition, where the at least one silane is selected from the group consisting of mercaptosilanes, blocked mercaptosilanes, and alkoxysilanes.

In a second embodiment, a tire rubber composition is provided. The tire rubber composition comprises (a) 100 parts of a rubber component including a majority by weight of guayule rubber where the guayule rubber includes a bagasse component, (b) a filler component, where the filler component is free of silica, and (c) at least one silane selected from the group consisting of mercaptosilanes, blocked mercaptosilanes, and alkoxysilanes.

### Definitions

The terminology as set forth herein is for description of the embodiments only and should not be construed as limiting the invention as a whole.

As used herein, the term “BR” or “polybutadiene” refers to homopolymer of 1,3-butadiene.

As used herein, the term “majority” refers to more than 50% (e.g., at least 50.1%, at least 50.5%, at least 51%, etc.).

As used herein, the term “minority” refers to less than 50% (e.g., no more than 49.5%, no more than 49%, etc.).

As used herein, the abbreviation Mn is used for number average molecular weight.

As used herein, the abbreviation Mp is used for peak molecular weight.

As used herein, the abbreviation Mw is used for weight average molecular weight.

Unless otherwise indicated herein, the term “Mooney viscosity” refers to the Mooney viscosity, ML₁₊₄. As those of skill in the art will understand, a rubber composition's Mooney viscosity is measured prior to vulcanization or curing.

As used herein, the term “natural rubber” means naturally occurring rubber such as can be harvested from sources such as Hevea rubber trees and non-Hevea sources (e.g., guayule plant and dandelions such as TKS). In other words, the term “natural rubber” should be construed so as to exclude synthetic polyisoprene.

As used herein, the term “guayule rubber” is a sub-category of natural rubber which has been harvested from the guayule plant. In contrast, natural rubber which has not been harvested from the guayule plant is referred to herein as “non-guayule natural rubber” and can include Hevea rubber as well as other sources such as dandelion.

As used herein, the term “phr” means parts per one hundred parts rubber. The one hundred parts rubber is also referred to herein as 100 parts of a rubber component.

As used herein the term “polyisoprene” means synthetic polyisoprene. In other words, the term is used to indicate a polymer that is manufactured from isoprene monomers, and should not be construed as including naturally occurring rubber (e.g., Hevea natural rubber, guayule-sourced natural rubber, or dandelion-sourced natural rubber). However, the term polyisoprene should be construed as including polyisoprenes manufactured from natural sources of isoprene monomer.

As used herein the term “SBR” means styrene-butadiene copolymer rubber.

As used herein, the term “tread,” refers to the portion of a tire that comes into contact with the road under normal inflation and load and the term “subtread” refers to the portion underlying the tread which does not generally come into contact with the road.

### Rubber Component

As mentioned above, according to the first and second embodiments, the tire rubber composition includes a rubber component which includes a majority by weight of guayule rubber (e.g., 51%, 55%, 60%, 65%, 70%, 75%, 80%, 85%, 90%, 95% or 100%) where the guayule rubber includes a bagasse component. In certain embodiments of the first and second embodiments, the rubber component includes at least 60% by weight of guayule rubber (e.g., 60%, 65%, 70%, 75%, 80%, 85%, 90%, 95%, 100%, 60-100%, 60-90%, 60-80%, 60-70%, etc.). In certain embodiments of the first and second embodiments the rubber component includes at least 70% by weight of guayule rubber (e.g., 70%, 75%, 80%, 85%, 90%, 95%, 100%, 70-100%, 70-90%, 70-80%, etc.). In yet other embodiments of the first and second embodiments, the entirety of the rubber component (i.e., 100% by weight) is guayule rubber.

According to the first and second embodiments disclosed herein, the guayule rubber that is used in the rubber composition may vary in Mw and Mn. In preferred embodiments of the first and second embodiments, the guayule rubber has a Mw of at least 1 million grams/mole (e.g., 1, 1.1, 1.2, 1.3, 1.4, 1.5, 1.6, 1.7, 1.8, 1.9, 2 million, or more) or 1 million to 2 million grams/mole (e.g., 1, 1.1, 1.2, 1.3, 1.4, 1.5, 1.6, 1.7, 1.8, 1.9, or 2 million), preferably 1.3 million to 2 million grams/mole (e.g., 1.3, 1.4, 1.5, 1.6, 1.7, 1.8, 1.9, or 2 million), more preferably 1.5 million to 2 million grams/mole (e.g., 1, 1.5, 1.6, 1.7, 1.8, 1.9, or 2 million). In preferred embodiments of the first and second embodiments, the guayule rubber has an Mn of at least 200,000 grams/mole (e.g., 200,000; 250,000; 300,000; 350,000; 400,000; 450,000; 500,000; 550,000; or more) or 200,000 to 500,000 grams/mole (e.g., 200,000; 250,000; 300,000; 350,000; 400,000; 450,000; or 500,000), more preferably at least 300,000 grams/mole (e.g., 300,000; 350,000; 400,000; 450,000; 500,000; 550,000; or more) or 300,000 to 500,000 grams/mole (e.g., 300,000; 350,000; 400,000; 450,000; or 500,000). In certain embodiments of the first and second embodiments, the guayule rubber has a Mw and Mn that are each within one of the foregoing ranges, preferably a Mw and Mn that are each within one of the foregoing preferred ranges, and more preferably a Mw and Mn that are each within one of the foregoing more preferred ranges.

In certain embodiments of the first and second embodiments disclosed herein, the amount of guayule resin that is present in the guayule rubber is limited. In preferred embodiments of the first and second embodiments, the guayule rubber includes no more than 5% by weight guayule resin (e.g., 5%, 4.5%, 4%, 3.5%, 3%, 2.5%, 2%, 1.5%, 1%, 0.5% or less), preferably no more than 4% by weight guayule resin (e.g., 4%, 3.5%, 3%, 2.5%, 2%, 1.5%, 1%, 0.5% or less) of guayule resin, more preferably less than 4% of guayule resin (e.g., 3.9%, 3.5%, 3%, 2.5%, 2%, 1.5%, 1%, 0.5% or less) of guayule resin, even more preferably less than 1% of guayule resin (e.g., 0.9%, 0.8%, 0.7%, 0.6%, 0.5%, 0.4%, 0.3%, 0.2%, 0.1% or 0%) of guayule resin.

According to the first and second embodiments disclosed herein, the amount of bagasse that is present in the guayule rubber (i.e., the bagasse component) may vary. In preferred embodiments of the first and second embodiments, the bagasse component comprises 1-20% by weight (e.g., 1%, 2%, 3%, 4%, 5%, 6%, 7%, 8%, 9%, 10%, 11%, 12%, 13%, 14%, 15%, 16%, 17%, 18%, 19%, or 20%) of the guayule rubber. In certain embodiments of the foregoing, the bagasse component more preferably comprises 1-10% by weight (e.g., 1%, 2%, 3%, 4%, 5%, 6%, 7%, 8%, 9%, or 10%) of the guayule rubber or less than 5% by weight (e.g., 4.9%, 4.5%, 4%, 3.5%, 3%, 2.5%, 2%, 1.5%, 1%, 0.5%, 0.4%, 0.3%, 0.2%, 0.1% or less than 0.1%). Generally, according to current technology methods, guayule rubber which contains 0.00% by weight of bagasse is not available. Accordingly, the amounts of 0.1% or less or less than 0.1% should be understood as including a minute amount of bagasse. In other embodiments of the first and second embodiments, the bagasse component comprises 5-20% by weight (e.g., 5%, 6%, 7%, 8%, 9%, 10%, 11%, 12%, 13%, 14%, 15%, 16%, 17%, 18%, 19%, or 20%), preferably 10-20% by weight (e.g., 10%, 11%, 12%, 13%, 14%, 15%, 16%, 17%, 18%, 19%, or 20%) based upon the weight of the guayule rubber. Embodiments of the first and second embodiments wherein relatively more bagasse is present in the guayule rubber (e.g., 5-20% by weight or 10-20% by weight) can present advantages in terms of isolation of the guayule rubber from the guayule plant since permitting more bagasse to be present can reduce the processing costs and time associated with isolation of the guayule rubber from the guayule plant.

Overall, according to the first and second embodiments, the overall amount of rubber present in the rubber component of the rubber composition should be understood to be 100 parts. Thus, in certain embodiments of the first and second embodiments, the rubber component can be understood as including as a minority by weight at least one additional rubber. The particular amount that constitutes the minority by weight of the at least one additional rubber will vary depending upon the amount of guayule rubber used. As a non-limiting example, if the rubber component includes 60% by weight of guayule rubber (or 60 part of guayule rubber), then 40% by weight of the rubber component will be comprised of the at least one additional rubber(s). Thus, generally when at least one additional rubber is present, it will constitute amounts such as 49-1%, 49-5%, 49-10%, 40-1%, 40-5%, 40-10%, 30-1%, 30-5%, 30-10% (all amounts by weight based upon the total weight of the rubber component), etc. The particular additional rubbers or rubbers used can vary. In preferred embodiments of the first and second embodiments, the rubber component includes a minority by weight of at least one rubber selected from the group consisting of non-guayule natural rubber (e.g., Hevea natural rubber or natural rubber from a non-Hevea and non-guayule source such as dandelion), polyisoprene, polybutadiene having a cis-1,4-bond content of at least 90%, functionalized polybutadiene having a cis-1,4-bond content of at least 90%, styrene-butadiene rubber, and functionalized styrene-butadiene rubber.

In those embodiments of the first and second embodiments wherein the rubber component includes a functionalized rubber (e.g., functionalized polybutadiene having a cis-1,4-bond content of at least 90% and/or a functionalized SBR), the functional group or groups present may vary. According to preferred embodiments of the foregoing, the functional group used is carbon black reactive, and in more preferred embodiments the functional group includes a polar group. Non-limiting examples of suitable functional groups (for BRs and SBRs) include, but are not limited to hydroxyl, carbonyl, ether, ester, halide, amine, imine, amide, nitrile, and oxirane (e.g., epoxy ring) groups. When a functionalized polymer is used, the functional group may be incorporated into the head and/or tail of the polymer and/or may be added along the polymer backbone. Non-limiting examples of functionalized initiators include organic alkaline metal compounds (e.g., an organolithium compound) that additionally include one or more heteroatoms (e.g., nitrogen, oxygen, boron, silicon, sulfur, tin, and phosphorus atoms) or heterocyclic groups containing the foregoing, frequently one or more nitrogen atoms (e.g., substituted aldimines, ketimines, secondary amines, etc.) optionally pre-reacted with a compound such as diisopropenyl benzene. Many functional initiators are known in the art. Exemplary ones are disclosed in U.S. Pat. Nos. 5,153,159, 5,332,810, 5,329,005, 5,578,542, 5,393,721, 5,698,464, 5,491,230, 5,521,309, 5,496,940, 5,567,815, 5,574,109, 5,786,441, 7,153,919, 7,868,110 and U.S. Patent Application Publication No. 2011-0112263, which are incorporated herein by reference. In certain embodiments of the first and second embodiments when a functional initiator is used, a functional nitrogen-containing initiator is utilized; non-limiting examples include cyclic amines, particularly cyclic secondary amines such as azetidine; pyrrolidine; piperidine; morpholine; N-alkyl piperazine; hexamethyleneimine; heptamethyleneimine; and dodecamethyleneimine.

### Styrene-Butadiene Rubbers

According to the first and second embodiments disclosed herein, when at least one SBR is present in the rubber component of the rubber composition, the Mw, Mn and polydispersity (Mw/Mn) of the styrene-butadiene rubber(s) may vary. In certain embodiments of the first and second embodiments, the SBR(s) have a Mw of 300,000 to 600,000 grams/mole (e.g., 300,000; 325,000; 350,000; 375,000; 400,000; 425,000; 450,000; 475,000; 500,000; 525,000; 550,000; 575,000; or 600,000 grams/mole). In certain embodiments of the first and second embodiments, the SBR(s) have a Mw of 350,000 to 550,000, or 400,000 to 500,000 grams/mole. The Mw values referred to herein are weight average molecular weights which can be determined by using gel permeation chromatography (GPC) calibrated with styrene-butadiene standards and Mark-Houwink constants for the polymer in question. In certain embodiments of the first and second embodiments, the SBR(s) have a Mn of 200,000 to 400,000 grams/mole (e.g., 200,000; 225,000; 250,000; 275,000; 300,000; 325,000; 350,000; 375,000; or 400,000 grams/mole). In certain embodiments of the first and second embodiments, the SBR(s) have a Mn of 200,000 to 300,000. The Mn values referred to herein are number average molecular weights which can be determined by using gel permeation chromatography (GPC) calibrated with styrene-butadiene standards and Mark-Houwink constants for the polymer in question. In certain embodiments of the first and second embodiments disclosed herein, the SBR(s) have a Mw/Mn (polydispersity) of 1.2 to 2.5 to (e.g., 1.2, 1.3, 1.4, 1.5, 1.6, 1.7, 1.8, 1.9, 2, 2.1, 2.2, 2.3, 2.4, or 2.5, preferably 1.3 to 2. In certain embodiments of the first and second embodiments, the SBR(s) have a Mw, Mn and Mw/Mn all falling within one of the foregoing ranges; in certain such embodiments, each of the Mw, Mn and Mw/Mn fall within one of the foregoing preferred ranges. In other embodiments of the first and second embodiments, the SBR(s) utilized either (a) include at least one of the foregoing SBRs having a Mw, Mn, and/or Mn/Mn falling within one of the foregoing ranges in combination with an SBR having a Mw of 350,000 to 600,000 grams/mole (e.g., 350,000; 400,000; 450,000; 500,000; 550,000; or 600,000 grams/mole) or 400,000 to 550,000 grams/mole (e.g., 400,000; 425,000; 450,000; 475,000; 500,000; 525,000; or 550,000 grams/mole), (b) or only include one or more SBRs having a Mw of 350,000 to 600,000 grams/mole (e.g., 350,000; 400,000; 450,000; 500,000; 550,000; or 600,000 grams/mole) or 400,000 to 550,000 grams/mole (e.g., 400,000; 425,000; 450,000; 475,000; 500,000; 525,000; or 550,000 grams/mole).

According to the first and second embodiments, the Tg of any SBR used in the rubber component may vary. In certain preferred embodiments of the first and second embodiments, the SBR(s) have a Tg of about −75 to about −50° C., −75 to −50° C. (e.g., −75, −70, −65, −60, −55, or −50° C.), preferably −70 to −55° C. (e.g., −70, −65, −60, or −55° C.), or more preferably −65 to −55° C. (e.g., −65, −60, or −55° C.). In other embodiments of the first and second embodiments, the SBR(s) utilized include a SBR having a Tg of about −10 to about −70° C., −10 to −70° C. (e.g., −10, −15, −20, −25, −30, −35, −40, −45, −50, −55, −60, −65, or −70° C.), preferably about −10 to about −49° C. or −10 to −49° C. (e.g., −10, −12, −14, −15, −16, −18, −20, −22, −24, −26, −28, −30, −32, −34, −36, −35, −38, −40, −42, −44, −45, −46, −48, or −49° C.). The SBR(s) may have a Tg within one of the foregoing ranges, optionally in combination with one or more of the Mw, Mn, and/or Mw/Mn ranges discussed above, and in certain embodiments optionally in combination with one of the styrene monomer contents discussed below. The Tg values referred to herein for elastomers represent a Tg measurement made upon the elastomer without any oil-extension. In other words, for an oil-extended elastomer, the Tg values above refer to the Tg prior to oil extension or to a non-oil-extended version of the same elastomer. Elastomer or polymer Tg values may be measured using a differential scanning calorimeter (DSC) instrument, such as manufactured by TA Instruments (New Castle, Delaware), where the measurement is conducted using a temperature elevation of 10° C./minute after cooling at −120° C. Thereafter, a tangent is drawn to the base lines before and after the jump of the DSC curve. The temperature on the DSC curve (read at the point corresponding to the middle of the two contact points) can be used as Tg.

According to the first and second embodiments, the styrene monomer content (i.e., weight percent of the polymer chain comprising styrene units as opposed to butadiene units) of any SBR(s) used in the rubber component may vary. In certain embodiments of the first and second embodiments, the SBR(s) have a styrene monomer content of about 10 to about 40 weight %, 10-40 weight % (e.g., 10%, 15%, 20%, 25%, 30%, 35%, or 40%), 10-30 weight % (e.g., 10%, 15%, 20%, 25%, or 30%), or 10-20 weight % (e.g., 10%, 12%, 14%, 16%, 18%, or 20%). In certain embodiments of the first and second embodiments, the SBR(s) may have a styrene monomer content within one of the foregoing ranges, optionally in combination with one or more of the Mw, Mn, and/or Mw/Mn ranges discussed below, and in certain embodiments optionally in combination with one of the Tg ranges discussed above and/or vinyl bond contents discussed below.

According to the first and second embodiments, the vinyl bond content (i.e., 1,2-microstructure) of any SBR(s) used in the elastomer component may vary. In certain embodiments of the first and second embodiments, the SBR has a vinyl bond content of about 10 to about 50%, 10-50% (e.g., 10%, 15%, 20%, 25%, 30%, 35%, 40%, 45%, or 50%), about 10 to about 40%, 10-40% (e.g., 10%, 15%, 20%, 25%, 30%, 35%, or 40%), about 20 to about 40%, or 20-40% (e.g., 20%, 25%, 30%, 35%, or 40%). In certain embodiments of the first and second embodiments, the SBR(s) may have a vinyl bond content within one of the foregoing ranges, optionally in combination with one or more of the Mw, Mn, Mw/Mn, Tg, and/or styrene monomer content ranges discussed above. The vinyl bond contents referred to herein should be understood as being for the overall vinyl bond content in the SBR polymer chain rather than of the vinyl bond content in the butadiene portion of the SBR polymer chain, and can be determined by H¹-NMR and C¹³-NMR (e.g., using a 300 MHz Gemini 300 NMR Spectrometer System (Varian)).

### Polybutadiene

According to the first and second embodiments, the rubber component of the rubber composition may include polybutadiene rubber. The particular type of polybutadiene rubber utilized may vary. Preferably, according to the first and second embodiments, any polybutadiene rubber present in the rubber component has a cis bond content of at least 90% (e.g., 90%, 91%, 92%, 93%, 94%, 95%, 96%, 97%, 98%, 99%, or more), preferably at least 92% (e.g., 92%, 93%, 94%, 95%, 96%, 97%, 98%, 99%, or more), more preferably at least 95% (e.g., 95%, 96%, 97%, 98%, 99%, or more) and a Tg of less than −101° C. (e.g., −102, −103, −104, −105, −106, −107, −108, −109° C. or less). In certain such embodiments, the Tg of the polybutadiene rubber is −101 to −110° C. The cis bond content refers to the cis 1,4-bond content. The cis 1,4-bond contents referred to herein are determined by FTIR (Fourier Transform Infrared Spectroscopy) wherein a polymer sample is dissolved in CS₂ and then subjected to FTIR. In certain embodiments of the first and second embodiments, the polybutadiene rubber present in the rubber component may have a cis 1,4-bond content of at least 98% (e.g., 98%, 99%, or more) or at least 99% (e.g., 99%, 99.5%, or more). In certain embodiments of the first and second embodiments, any polybutadiene rubber present in the rubber component has a Tg of −105° C. or less (e.g., −105, −106, −107, −108, −109° C. or less) such as −105 to −110° C. or −105 to −108° C. In certain embodiments of the first and second embodiments, any polybutadiene rubber present in the rubber component contains less than 3% by weight (e.g., 3%, 2%, 1%, 0.5%, or less), preferably less than 1% by weight (e.g., 1%, 0.5%, or less) or 0% by weight syndiotactic 1,2-polybutadiene. Generally, according to the first and second embodiments, one or more than one polybutadiene rubber having a cis bond content of at least 92% and a Tg of less than −101° C. may be used in the rubber component. In certain embodiments of the first-third embodiments, the only polybutadiene rubber used has a cis bond content of at least 92% (e.g., 92%, 93%, 94%, 95%, 96%, 97%, 98%, 99%, or more) and a Tg of less than −101° C. As mentioned above, when a polybutadiene is present in the rubber component, it may optionally be functionalized, using one or more of the functional groups discussed above.

According to the first and second embodiments, when a polybutadiene rubber is used in the rubber composition, the amount utilized may vary. Since the guayule rubber is present in a majority amount, the total amount of any polybutadiene rubber present in the rubber component will be a minority by weight, or less than 50% by weight. In such embodiments of the first and second embodiments, the total amount of polybutadiene rubber present in the rubber r component is less than 50 phr, less than 40 phr, less than 30 phr, less than 20 phr, or less than 10 phr. In certain embodiments of the first and second embodiments, the total amount of polybutadiene rubber present in the rubber component is 5-49 phr, 5-40 phr, 5-30 phr, 5-20 phr, 5-10 phr, 10-49 phr, 10-40 phr, 10-30 phr, 10-20 phr, 20-49 phr, 20-40 phr, or 20-30 phr.

### Non-Guayule Natural Rubber or Polyisoprene

According to the first and second embodiments, the rubber component may include non-guayule natural rubber, polyisoprene, or a combination thereof. In certain embodiments of the first and second embodiment, the rubber component includes non-guayule natural rubber, but not polyisoprene. In other embodiments of the first and second embodiments, the rubber component includes only polyisoprene, but not natural rubber. According to the first and second embodiments, when natural rubber is present in the rubber component, it is preferably Hevea natural rubber. When non-guayule natural rubber is used in the rubber composition of the first and second embodiments, the natural rubber preferably has a Mw of 1,000,000 to 2,000,000 grams/mole (e.g., 1 million, 1.1 million, 1.2 million, 1.3 million, 1.4 million, 1.5 million, 1.6 million, 1.7 million, 1.8 million, 1.9 million, 2 million grams/mole); 1,250,000 to 2,000,000 grams/mole, or 1,500,000 to 2,000,000 grams/mole (as measured by GPC using a polystyrene standard). When non-guayule natural rubber is used in the rubber compositions of the first and second embodiments, the Tg of the natural rubber may vary. Preferably, according to the first and second embodiments, when non-guayule natural rubber is utilized it has a Tg of −65 to −80° C. (e.g., −65, −66, −67, −68, −69, −70, −71−, −72, −73, −74, −75, −76, −77, −78, −79, or −80° C.), more preferably a Tg of −67 to −77° C. (e.g., −67, −68, −69, −70, −71, −72, −73, −74, −75, −76, or −77° C.). When polyisoprene is utilized in the rubber compositions of the first and second embodiments, the Tg of the polyisoprene may vary. Preferably, according to the first and second embodiments, when polyisoprene is utilized it has a Tg of −55 to −75° C. (e.g., −55, −56, −57, −58, −59, −60, −61, −62, −63, −64, −65, −66, −67, −68, −69, −70, −71, −72, −73, −74, or −75° C.), more preferably −58 to −74° C. (e.g., −58, −59, −60, −61, −62, −63, −64, −65, −66, −67, −68, −69, −70, −71, −72, −73, or −74° C.).

According to the first and second embodiments, when non-guayule natural rubber and/or polyisoprene are used in the rubber composition, the amount utilized may vary. Generally, according to the first and second embodiments, since the guayule rubber is used in a majority amount the total amount of any non-guayule natural rubber and/or polyisoprene present in the rubber component will be a minority by weight, or less than 50% by weight. In certain embodiments of the first and second embodiments, the total amount of non-guayule natural rubber and/or polyisoprene present in the rubber component is less than 50 phr, less than 40 phr, less than 30 phr, less than 20 phr, or less than 10 phr. In certain embodiments of the first and second embodiments, the total amount of non-guayule natural rubber and/or polyisoprene present in the rubber component is 5-49 phr, 5-40 phr, 5-30 phr, 5-20 phr, 5-10 phr, 10-49 phr, 10-40 phr, 10-30 phr, 10-20 phr, 20-49 phr, 20-40 phr, or 20-30 phr. In certain embodiments of the first and second embodiments, the rubber component includes non-guayule natural rubber but no polyisoprene, and the amount of natural rubber is within one of the foregoing ranges.

### Filler Component

As mentioned above, according to the first and second embodiments, the rubber composition includes a filler component where the filler component is free of silica. By free of silica is meant that the filler component (and, thus, the overall rubber composition) contains 0 phr of silica. Without being bound by theory, exclusion of silica from the filler component allows for the bonding of the at least one silane to the bagasse component (rather than bonding of the at least one silane to silica). According to the first and second embodiments disclosed herein, the amount and type of filler or fillers present in the filler component of the rubber composition may vary.

In certain preferred embodiments of the first and second embodiments disclosed herein, the filler component is present in an amount of 30-200 phr (e.g., 30, 40, 50, 60, 70, 80, 90, 100, 110, 120, 130, 140, 150, 160, 170, 180, 190 or 200 phr), more preferably 30-150 phr (e.g., 30, 40, 50, 60, 70, 80, 90, 100, 110, 120, 130, 140, or 150 phr) or 40-120 phr (e.g., 30, 40, 50, 60, 70, 80, 90, 100, 110, 120, 130, or 140 phr). In certain preferred embodiments of the first and second embodiments disclosed herein, the filler component is present in one of the foregoing amounts and includes a majority by weight of reinforcing carbon black (including e.g., at least 60% by weight reinforcing carbon black, at least 70% by weight reinforcing carbon black, at least 80% by weight reinforcing carbon black, and at least 90% by weight reinforcing carbon black). In certain of the foregoing embodiments, the filler component is entirely reinforcing carbon black, i.e., 100% by weight of the filler component is reinforcing carbon black.

According to the first and second embodiments, the particular type or types of carbon black utilized may vary. Generally, suitable carbon blacks for use as a reinforcing filler in the rubber composition of certain embodiments of the first and second embodiments include any of the commonly available, commercially-produced carbon blacks, including those having a surface area of at least about 20 m²/g (including at least 20 m²/g) and, more preferably, at least about 35 m²/g up to about 200 m²/g or higher (including 35 m²/g up to 200 m²/g). Surface area values used herein for carbon blacks are determined by ASTM D-1765 using the cetyltrimethyl-ammonium bromide (CTAB) technique. Among the useful carbon blacks are furnace black, channel blacks, and lamp blacks. More specifically, examples of useful carbon blacks include super abrasion furnace (SAF) blacks, high abrasion furnace (HAF) blacks, fast extrusion furnace (FEF) blacks, fine furnace (FF) blacks, intermediate super abrasion furnace (ISAF) blacks, semi-reinforcing furnace (SRF) blacks, medium processing channel blacks, hard processing channel blacks and conducting channel blacks. Other carbon blacks which scan be utilized include acetylene blacks. In certain embodiments of the first and second embodiments, the rubber composition includes a mixture of two or more of the foregoing blacks. Preferably according to the first and second embodiments, if a carbon black filler is present it consists of only one type (or grade) of reinforcing carbon black. Typical suitable carbon blacks for use in certain embodiments of the first and second embodiments are N-110, N-220, N-339, N-330, N-351, N-550, and N-660, as designated by ASTM D-1765-82a. The carbon blacks utilized can be in pelletized form or an unpelletized flocculent mass. Preferably, for more uniform mixing, unpelletized carbon black is preferred.

In certain embodiments of the first and second embodiments, the tread rubber composition comprises a reinforcing filler other than carbon black (i.e., an additional reinforcing filler). While one or more than one additional reinforcing filler may be utilized, their total amount is preferably limited to no more than 10 phr (e.g., 10, 9, 8, 7, 6, 5, 4, 3, 2, 1 or 0 phr), or no more than 5 phr (e.g., 5, 4, 3, 2, 1, or 0 phr). In certain preferred embodiments of the first and second embodiments, the tread rubber composition contains no additional reinforcing filler (i.e., 0 phr); in other words, in such embodiments no reinforcing filler other than carbon black is present.

In those embodiments of the first and second embodiments wherein an additional reinforcing filler is utilized, the additional reinforcing filler or fillers may vary. Non-limiting examples of suitable additional reinforcing fillers for use in the rubber compositions of certain embodiments of the first and second embodiments include, but are not limited to, alumina, aluminum hydroxide, clay (reinforcing grades), magnesium hydroxide, boron nitride, aluminum nitride, titanium dioxide, reinforcing zinc oxide, and combinations thereof.

In certain embodiments of the first and second embodiments, the rubber composition comprises (includes) at least one non-reinforcing filler which is a non-carbon black non-reinforcing filler. In other preferred embodiments of the first and second embodiments, the rubber composition contains no non-carbon black non-reinforcing fillers (i.e., 0 phr). In yet other embodiments of the first and second embodiments, the rubber composition contains no non-reinforcing fillers (in such embodiments, the carbon black filler of the filler component will be a reinforcing carbon black filler). In embodiments of the first and second embodiments wherein at least one non-carbon black non-reinforcing filler is utilized, the at least one non-reinforcing filler may be selected from clay (non-reinforcing grades), graphite, magnesium dioxide, aluminum oxide, starch, boron nitride (non-reinforcing grades), silicon nitride, aluminum nitride (non-reinforcing grades), calcium silicate, silicon carbide, ground rubber, and combinations thereof. In certain preferred embodiments of the first and second embodiments, the rubber composition includes 1-20 phr (e.g., 1, 2, 3, 4, 5, 6, 7, 8, 9, 10, 11, 12, 13, 14, 15, 16, 17, 18, 19, or 20 phr) of ground rubber, preferably 1-5 phr (e.g., 1, 2, 3, 4, or 5 phr) of ground rubber. The term “non-reinforcing filler” is used to refer to a particulate material that has a nitrogen absorption specific surface area (N₂SA) of less than about 20 m²/g (including less than 20 m²/g), and in certain embodiments less than about 10 m²/g (including less than 10 m²/g). The N₂SA surface area of a particulate material can be determined according to various standard methods including ASTM D6556. In certain embodiments, the term “non-reinforcing filler” is alternatively or additionally used to refer to a particulate material that has a particle size of greater than about 1000 nm (including greater than 1000 nm). In those embodiments of the first and second embodiments, wherein a non-carbon black non-reinforcing filler is present in the rubber composition, the total amount of non-carbon black non-reinforcing filler may vary but is preferably no more than 20 phr (e.g., 20, 19, 18, 17, 16, 15, 14, 13, 12, 11, 10, 9, 8, 7, 6, 5, 4, 3, 2, or 1 phr), and in certain embodiments 1-10 phr, no more than 10 phr, no more than 5 phr (e.g., 5, 4, 3, 2, or 1 phr), 1-5 phr, or no more than 1 phr.

### At Least One Silane

As mentioned above, according to the first and second embodiments, the rubber composition includes at least one silane that is selected from the group consisting of mercaptosilanes, blocked mercaptosilanes and alkoxysilanes. As discussed in more detail below, the alkoxysilanes should be understood to include both sulfur-containing alkoxysilanes as well as non-sulfur-containing alkoxysilanes.

According to the first and second embodiments, the amount of the at least one silane that is used in the rubber composition may vary. Generally, the amount of silane that is used can be adjusted depending upon the total amount of bagasse that is present in the rubber composition (the bagasse generally being present as a component of the guayule rubber). The amount of bagasse may vary depending upon its concentration in the guayule rubber (generally 1-20% by weight) and depending upon the amount of guayule rubber used in the rubber composition. In preferred embodiments of the first and second embodiments, the at least one silane is present in a total amount of 0.1 to 5 phr (e.g., 0.1, 0.2, 0.3, 0.4, 0.5, 0.6, 0.7, 0.8, 0.9, 1, 1.5, 2, 2.5, 3, 3.5, 4, 4.5, or 5 phr), more preferably in a total amount of 0.2 to 1 phr (e.g., 0.2, 0.3, 0.4, 0.5, 0.6, 0.7, 0.8, 0.9, or 1 phr). In preferred embodiments of the first and second embodiments, the at least one silane is present in a total amount of 5-20% by weight (e.g., 5, 6, 7, 8, 9, 10, 11, 12, 13, 14, 15, 16, 17, 18, 19 or 20% by weight) based upon the amount of bagasse present in the rubber composition. As a non-limiting example, if the rubber component of the rubber composition included 70% by weight of a guayule rubber (i.e., 70% by weight of the rubber component was guayule rubber) which guayule rubber contained 10% by weight bagasse, the amount of bagasse in the rubber composition would be 7 phr. Applying the amount of 5-20% by weight to 7 phr of bagasse would result in a silane amount ranging from 0.35 phr (i.e., 5%) to 1.4 phr (i.e., 20%). In certain embodiments of the first and second embodiments, the at least one silane is present in a total amount of 0.1 to 5 phr (preferably 0.2 to 1 phr) and is also present in a total amount of 5-20% by weight based upon the amount of bagasse in the rubber composition.

According to the first and second embodiments disclosed herein, one or more than one silane (as discussed above) can be used in the rubber composition. In preferred embodiments of the first and second embodiments, the rubber composition includes only one silane selected from the group consisting of mercaptosilanes, blocked mercaptosilanes and alkoxysilanes. In other embodiments of the first and second embodiments, the rubber composition includes two silanes selected from the group consisting of mercaptosilanes, blocked mercaptosilanes and alkoxysilanes. In those embodiments where two (or more) silanes are used in the rubber composition, the total amount of all silanes is as discussed above.

In certain embodiments of the first and second embodiments disclosed herein, the at least one silane is a non-sulfur containing alkoxysilane. Preferably according to such embodiments, the non-sulfur containing alkoxysilane has formula (I):

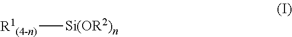

where n=2, 3, or 4; each R¹ is independently selected from a hydrocarbyl group having 1-20 carbons, preferably 2-18 carbons; and R² is an alkyl group having 1-10 carbons, preferably 1-6, more preferably 1-3 carbons or an aromatic group having 6-18 carbons, preferably 6-12 carbons. When n=2, the non-sulfur containing alkoxysilane can be understood as being a dialkoxysilane. When n=3, the non-sulfur containing alkoxysilane can be understood as being a trialkoxysilane. When n=4, the non-sulfur containing alkoxysilane can be understood as being a tetraalkoxysilane.

In certain embodiments of the first and second embodiments, the at least one silane is a non-sulfur containing alkoxysilane silane having formula (I) where n=2, i.e., a dialkoxysilane. Non-limiting examples of non-sulfur containing alkoxysilanes which are dialkoxysilanes include, but are not limited to, dimethyl diimethoxysilane, dimethyl diiethoxysilane, dimethyl dipropoxysilane, dimethyl diisopropoxysilane, diethyl dimethoxysilane, diethyl diethoxysilane, diethyl dipropoxysilane, diethyl diisopropoxysilane, dipropyl dimethoxysilane, dipropyl diethoxysilane, dibutyl dimethoxysilane, dibutyl diiethoxysilane, dipentyl dimethoxysilane, dipentyl diethoxysilane, dihexyl dimethoxysilane, dihexyl diethoxysilane, diheptyl dimethoxysilane, diheptyl diethoxysilane, dioctyl dimethoxysilane, dioctyl diethoxysilane, dinonyl dimethoxysilane, dinonyl diethoxysilane, didecyl dimethoxysilane, didecyl diethoxysilane, diundecyl dimethoxysilane, diundecyl diethoxysilane, didodecyl dimethoxysilane, didodecyl diethoxysilane, ditridecyl dimethoxysilane, ditridecyl diethoxysilane, ditetradecyl dimethoxysilane, dipentadecyl dimethoxysilane, ditetradecyl diethoxysilane, dipentadecyl diethoxysilane, dihexadecyl dimethoxysilane, dihexadecyl diethoxysilane, diheptadecyl dimethoxysilane, diheptadecyl diethoxysilane, dioctadecyl dimethoxysilane, dioctadecyl diethoxysilane, dinonadecyl dimethoxysilane, dinonadecyl diethoxysilane, diphenyl dimethoxysilane, diphenyl diethoxysilane, diphenyl dipropoxysilane, diphenyl diisopropoxysilane, dibenzyl dimethoxysilane, dibenzyl diethoxysilane.

In certain embodiments of the first and second embodiments, the at least one silane is a non-sulfur containing alkoxysilane silane having formula (I) where n=3, i.e., a trialkoxysilane. Non-limiting examples of non-sulfur containing alkoxysilanes which are trialkoxysilanes include, but are not limited to, methyl trimethoxysilane, methyl triethoxysilane, methyl tripropoxysilane, methyl triisopropoxysilane, ethyl trimethoxysilane, ethyl triethoxysilane, ethyl tripropoxysilane, ethyl triisopropoxysilane, propyl trimethoxysilane, propyl triethoxysilane, butyl trimethoxysilane, butyl triethoxysilane, pentyl trimethoxysilane, pentyl triethoxysilane, hexyl trimethoxysilane, hexyl triethoxysilane, heptyl trimethoxysilane, heptyl triethoxysilane, octyl trimethoxysilane, octyl triethoxysilane, nonyl trimethoxysilane, nonyl triethoxysilane, decyl trimethoxysilane, decyl triethoxysilane, undecyl trimethoxysilane, undecyl triethoxysilane, dodecyl trimethoxysilane, dodecyl triethoxysilane, tridecyl trimethoxysilane, tridecyl triethoxysilane, tetradecyl trimethoxysilane, tetradecyl triethoxysilane, pentadecyl trimethoxysilane, pentadecyl triethoxysilane, hexadecyl trimethoxysilane, hexadecyl triethoxysilane, heptadecyl trimethoxysilane, heptadecyl triethoxysilane, octadecyl trimethoxysilane, octadecyl triethoxysilane, nonadecyl trimethoxysilane, nonadecyl triethoxysilane, phenyl trimethoxysilane, phenyl triethoxysilane, phenyl tripropoxysilane, phenyl triisopropoxysilane, benzyl trimethoxysilane, benzyl triethoxysilane.

In certain embodiments of the first and second embodiments, the at least one silane is a non-sulfur containing alkoxysilane silane having formula (I) where n=4, i.e., a tetraalkoxysilane. Non-limiting examples of non-sulfur containing alkoxysilanes which are tetraalkoxysilanes include, but are not limited to, tetramethoxysilane, tetraethoxysilane, tetrapropoxysilane, tetra-isopropoxysilane, tetrabutoxysilane, and tetra-isobutoxysilane.

In certain embodiments of the first and second embodiments disclosed herein, the at least one silane is a non-sulfur containing bis-alkoxysilane. A non-sulfur containing bis-alkoxysilane can be understood as containing two silicon atoms, preferably separated by a divalent hydrocarbyl group, with each silicon atom having two or three alkoxygroups. In certain embodiments of the first and second embodiments, the non-sulfur containing bis-alkoxysilane has the formula (Y)G(Z) wherein G is a separating group selected from the group consisting of C₁-C₅₀ straight chain and branched alkylene, C₂-C₅₀ straight chain and branched alkenylene, C₅-C₅₀ aromatics, each optionally containing a heteroatom selected from the group consisting of one or more O, or one or more N, and combinations thereof; and Y and Z can be the same or different and each independently comprise a group of the formula Si(R⁷)ₚ(OR⁸)₃₋ₚ wherein each R⁷ independently comprises C₁-C₂₀ aliphatic, cycloaliphatic or aromatic, R⁸ is C₁-C₆ aliphatic or cycloaliphatic and p is an integer of 0 or 1. In preferred embodiments of the first and second embodiments, when the non-sulfur containing bis alkoxysilane has the foregoing formula, the G of the non-elastomer reactive filler reinforcing agent is selected from the group consisting of C₂-C₂₀ alkylene, and alkenylene, and C₆-C₂₀ aromatics, each optionally containing a heteroatom selected from the group consisting of one or more O or one or more N, and combinations thereof. In certain embodiments of the first and second embodiments, the non-sulfur containing bis-alkoxysilane has the formula (Y)G(Z) and G is selected from the group consisting of C₆-C₂₀ alkylene and alkenylene and each R⁸ is selected from the group consisting of C₁ to C₈ straight-chain and branched aliphatic. In certain embodiments of the first and second embodiments, the non-sulfur containing bis-alkoxysilane has the formula (Y)G(Z) and G selected from the group consisting of C₄-C₂₀ straight-chain and branched alkylene and C₄-C₂₀ straight-chain and branched alkenylene either optionally containing additional carbon atoms in the form of one or more aromatic rings. In particular embodiments, the non-sulfur containing bisalkoxysilane is a bis(trialkoxy)silane with the carbon portion of the alkoxy selected from the group consisting of C₁ to C₆ (i.e., methyl to hexyl), preferably C₁ to C₃ and even more preferably C₁ to C₂. Specific examples of such bis(trialkoxy)silanes include, but are not limited to, bis(trimethoxysilyl)ethane, bis(triethoxysilyl)ethane, bis(tributoxysilyl)ethane, bis(triethoxysilyl)propane, bis(trimethoxysilyl)propane, bis(tributoxysilyl)propane, bis(triethoxysilyl)butane, bis(trimethoxysilyl)butane, bis(tributoxysilyl)butane, bis(triethoxysilyl)isobutane, bis(tributoxysilyl)isobutane, bis(trimethoxysilyl)isobutane, bis(triethoxysilyl)hexane, bis(tributoxysilyl)hexane, bis(trimethoxysilyl)hexane, bis(triethoxysilyl)cyclohexane, bis(tributoxysilyl)cyclohexane, bis(trimethoxysilyl)cyclohexane, bis(trimethoxysilyl)heptane, bis(tributoxysilyl)heptane, bis(triethoxysilyl)heptane, bis(triethoxysilyl)octane, bis(tributoxysilyl)octane, bis(trimethoxysilyl)octane, bis(triethoxysilyl)nonane, bis(tributoxysilyl)nonane, bis(trimethoxysilyl)nonane, bis(triethoxysilyl)decane, bis(tributoxysilyl)decane, bis(trimethoxysilyl)decane, bis(triethoxysilyl)dodecane, bis(tributoxysilyl)dodecane, bis(trimethoxysilyl)dodecane, bis(triethoxysilyl)tetradecane, bis(trimethoxysilyl)tetradecane, bis(tributoxysilyl)tetradecane, bis(triethoxysilyl)octadecane, bis(trimethoxysilyl)octadecane, bis(tributoxysilyl)octadecane, and mixtures thereof.

In certain embodiments of the first and second embodiments disclosed herein, the at least one silane is a sulfur-containing alkoxysilane having 2-6 alkoxysilane groups. Preferably according to such embodiments, the sulfur-containing alkoxysilane is selected from disulfide alkoxysilanes or tetrasulfide alkoxysilanes. A disulfide alkoxysilane can be understood as having two sulfur atoms (single bonded to each other), each sulfur of which is bonded to a separating alkylene group that is bonded to a silicon atom that is in turn has two or three alkoxygroups. A tetrasulfide alkoxysilane can be understood as having four sulfur atoms (single bonded to each other), with the end sulfurs each bonded to a separating alkylene group that is bonded to a silicon atom that in turn has two or three alkoxygroups. In certain embodiments of the first and second embodiments, the disulfide alkoxysilane has the formula (alkoxy)ₐ(alkyl)₃₋ₐSi—(CH₂)_{b}S—S—(CH₂)_{b}—Si(alkyl)₃₋ₐ(alkoxy)ₐ where a is 2 or 3; b is an integer of 1 to 10, preferably 2 to 8, more preferably 2 or 3; and the alkyl in the alkoxy groups is selected from alkyl of 1-10 carbons, preferably 1 to 6 carbons, more preferably 1 to 4 carbons. In certain embodiments of the first and second embodiments, the tetrasulfide alkoxysilane has the formula (alkoxy)_{d}(alkyl)_{3-d}Si—(CH₂)ₑS—S—S—S—(CH₂)ₑ—Si(alkyl)_{3-d}(alkoxy)_{d} where d is 2 or 3; e is an integer of 1 to 10, preferably 2 to 8, more preferably 2 or 3; and the alkyl in the alkoxy groups is selected from alkyl of 1-10 carbons, preferably 1 to 6 carbons, more preferably 1 to 4 carbons. Alternatively, in other embodiments, the tetrasulfide alkoxysilane has the alkoxysilane alkylene moiety on only one end of the sulfur chain (e.g., the first sulfur) and at the other end of the sulfur chain (e.g., the fourth sulfur), another moiety is present (e.g., thiocarbamoyl, benzothiazole).

In certain embodiments of the first and second embodiments disclosed herein, when the at least one silane is a disulfide alkoxysilane it is selected from the group consisting of 3,3′-bis(triethoxysilylpropyl) disulfide, 3,3′-bis(trimethoxysilylpropyl) disulfide, 3,3′-bis(tributoxysilyl-propyl) disulfide, 3,3′-bis(tri-m-butoxysilyl-propyl) disulfide, 3,3′-bis(tripropoxypropyl) disulfide, 3,3′-bis(trihexoxysilylpropyl) disulfide, 2,21-bis(dimethylmethoxysilylethyl) disulfide, 3,31-bis(diphenylcyclohexoxysilylpropyl) disulfide, 3,3′-bis(ethyl-di-sec-butoxysilylpropyl) disulfide, 3,3′-bis(propyldiethoxysilylpropyl) disulfide, 3,3′-bis(triisopropoxysilylpropyl) disulfide, 12,12′-bis(triisopropoxysilylpropyl) disulfide, 3,3′-bis(dimethoxyphenylsilyl-2-methylpropyl) disulfide, and mixtures thereof.

In certain embodiments of the first and second embodiments disclosed herein, when the at least one silane is a tetrasulfide alkoxysilane, it is selected from the group consisting of bis(3-triethoxysilylpropyl) tetrasulfide, bis(2-triethoxysilylethyl) tetrasulfide, bis(3-trimethoxysilylpropyl) tetrasulfide, 3-trimethoxysilylpropyl-N,N-dimethylthiocarbamoyl tetrasulfide, 3-triethoxysilylpropyl-N,N-dimethylthiocarbamoyl tetrasulfide, 2-triethoxysilyl-N,N-dimethylthiocarbamoyl tetrasulfide, 3-trimethoxysilylpropyl-benzothiazole tetrasulfide, 3-triethoxysilylpropylbenzothiazole tetrasulfide, and mixtures thereof.

In certain embodiments of the first and second embodiments disclosed herein, the at least one silane is a mercaptosilane compound. In certain such embodiments, the at least one silane comprises a mercaptosilane; in other words, an additional silane selected from the group consisting of blocked mercaptosilanes and alkoxysilanes can be used in combination with the mercaptosilane. In other embodiments, the at least one silane consists of a mercaptosilane; in other words, the only type of silane used is a mercaptosilane and no blocked mercapto silane and no alkoxysilane is present in the rubber composition. Mercapto silane compounds can be described as having the general formula HS—R³—Si(Xₙ)(R⁴₃₋ₙ) where each X is independently selected from a halogen or an alkoxy group (if an alkoxy group, of the formula OR⁵ where R⁵ is a C₁ to C₆ aliphatic, cycloaliphatic or aromatic group); R³ is selected from a C₁ to C₄ alkylene; each R⁴ is independently selected from a C₁ to C₃₀ alkyl, C₇ to C₃₀ alkaryl, C₅ to C₃₀ cycloaliphatic or C₆ to C₂₀ aromatic; and n is an integer from 1 to 4. When X is a halogen, it can be selected from the group consisting of chlorine, bromine, iodine and fluorine, preferably chlorine. In certain preferred embodiments of the first and second embodiments disclosed herein, the at least one silane is a mercaptosilane having the above formula and R³ is selected from a C₁ to C₃ alkylene, X is an alkoxy group (with carbon portion of C₁ to C₆), and n is 3. 1-mercaptomethyltriethoxysilane, 2-mercaptoethyltriethoxysilane, 3-mercaptopropyltriethoxysilane, 3-mercaptopropylmethyldiethoxysilane, 2-mercaptoethyltriproxysilane, 18-mercaptooctadecyldiethoxychlorosilane

In certain embodiments of the first and second embodiments disclosed herein, the at least one silane is blocked mercapto silane. In certain such embodiments, the at least one silane comprises a blocked mercaptosilane; in other words, an additional silane selected from the group consisting of mercaptosilanes and alkoxysilanes can be used in combination with the blocked mercaptosilane. In other embodiments, the at least one silane consists of a blocked mercaptosilane; in other words, the only type of silane used is a blocked mercaptosilane and no mercapto silane and no alkoxysilane is present in the rubber composition. Blocked mercapto silanes can be described as having the general formula B—S—R⁶—Si—X₃ with a blocking group B that replaces the mercapto hydrogen atom to “block” the reaction of the sulfur atom with the polymer. In certain embodiments of the first and second embodiments, where the blocked mercaptosilane has the foregoing general formula, B is a blocking group which can be in the form of an unsaturated heteroatom or carbon bound directly to sulfur via a single bond; R⁶ is selected from a C₁ to C₆ linear or branched alkyl chain, and each X is independently selected from the group consisting of C₁ to C₆ alkyl, C₁ to C₆ alkoxy, halogen, halogen-containing C₁ to C₆ alkyl, and halogen-containing C₁ to C₆ alkoxy. Suitable blocked mercapto silanes for use in certain embodiments of the first and second embodiments disclosed herein, include, but are not limited to, those described in U.S. Pat. Nos. 6,127,468; 6,204,339; 6,528,673; 6,635,700; 6,649,684; 6,683,135; and 7,256,231. In certain embodiments of the first and second embodiments disclosed herein, when the at least one silane is a blocked mercapto silane it is selected from the group consisting of 2-triethoxysilyl-1-ethylthioacetate; 2-trimethoxysilyl-1-ethylthioacetate; 2-(methyldimethoxy-silyl)-1-ethylthioacetate; 3-trimethoxysilyl-1-propylthioacetate; triethoxysilylmethyl-thioacetate; trimethoxysilylmethylthioacetate; methyldiethoxysilylmethylthioacetate; triisopropoxysilylmethylthioacetate; methyldiiso-propoxysilylmethylthioacetate; methyldimethoxysilylmethylthioacetate; dimethylmethox-ysilylmethylthioacetate; dimethylethoxysilylmethylthioacetate; dimethylisopropoxysilylmethylthioacetate; 2-triisopropoxysilyl-1-ethylthioacetate; 2-(methyldiethoxysilyl)-1-ethylthioacetate, 2-2-(methyldiisopropoxysilyl)-1-ethylthioacetate; (dimethylethoxysilyl-1-ethylthioacetate; 2-(dimethylmethoxysilyl)-1-ethylthioacetate; 2-(dimethylisopropoxysilyl)-1-ethylthioacetate; 3-triethoxysilyl-1-propyl-thioacetate; 3-triisopropoxysilyl-1-propylthioacetate; 3-methyldiethoxysilyl-1-propyl-thioacetate; 3-methyldimethoxysilyl-1-propylthioacetate; 3-methyldiisopropoxysilyl-1-propylthioacetate; 1-(2-triethoxysilyl-1-ethyl)-4-thioacetylcyclohexane; 1-(2-triethoxysilyl-1-ethyl)-3-thioacetylcyclohexane; 2-triethoxysilyl-5-thioacetylnorbornene; 2-triethoxysilyl-4-thioacetylnorbornene; 2-(2-triethoxysilyl-1-ethyl)-5-thioacetylnorbornene; 2-(2-triethoxy-silyl-1-ethyl)-4-thioacetylnorbornene; 1-(1-oxo-2-thia-5-triethoxysilylphenyl)benzoic acid; 6-triethoxysilyl-1-hexylthioacetate; 1-triethoxysilyl-5-hexylthioacetate; 8-triethoxysilyl-1-octylthioacetate; 1-triethoxysilyl-7-octylthioacetate; 6-triethoxysilyl-1-hexylthioacetate; 1-triethoxysilyl-5-octylthioacetate; 8-trimethoxysilyl-1-octylthioacetate; 1-trimethoxysilyl-7-octylthioacetate; 10-triethoxysilyl-1-decylthioacetate; 1-triethoxysilyl-9-decylthioacetate; 1-triethoxysilyl-2-butylthioacetate; 1-triethoxysilyl-3-butylthioacetate; 1-triethoxysilyl-3-methyl-2-butylthioacetate; 1-triethoxysilyl-3-methyl-3-butylthioacetate; 3-trimethoxysilyl-1-propylthiooctanoate; 3-triethoxysilyl-1-propyl-1-propylthiopalmitate; 3-triethoxysilyl-1-propylthiooctanoate; 3-triethoxysilyl-1-propylthiobenzoate; 3-triethoxysilyl-1-propylthio-2-ethylhexanoate; 3-methyldiacetoxysilyl-1-propylthioacetate; 3-triacetoxysilyl-1-propylthioacetate; 2-triacetoxysilyl-1-2-methyldiacetoxysilyl-1-ethylthioacetate; ethylthioacetate; 1-triacetoxysilyl-1-ethyl-1-methyldiacetoxysilyl-1-ethylthioacetate; bis-(3-triethoxysilyl-1-thioacetate; tris-(3-triethoxysilyl-1-propyl)trithiophosphate; propyl)methyldithiophosphonate; bis-(3-triethoxysilyl-1-propyl)ethyldithiophosphonate; 3-triethoxysilyl-1-propyldimethylthiophosphinate; 3-triethoxysilyl-1-propyldiethylthiophosphinate; tris-(3-triethoxysilyl-1-propyl)tetrathiophosphate; bis-(3-triethoxysilyl-1propyl)methyltrithiophosphonate; bis-(3-triethoxysilyl-1-propyl)ethyltrithiophosphonate; 3-triethoxysilyl-1-propyldimethyldithiophosphinate; 3-triethoxysilyl-1-propyldiethyldithiophosphinate; tris-(3-methyldimethoxysilyl-1-propyl)trithiophosphate; bis-(3-methyl-dimethoxysilyl-1-propyl)methyldithiophosphonate; bis-(3-methyldimethoxysilyl-1-propyl)-ethyldithiophosphonate; 3-methyldimethoxysilyl-1-propyldimethylthiophosphinate; 3-methyldimethoxysilyl-1-propyldiethylthiophosphinate; 3-triethoxysilyl-1-propylmethyl-thiosulfate; 3-triethoxysilyl-1-propylmethanethiosulfonate; 3-triethoxysilyl-1-propyl-ethanethiosulfonate; 3-triethoxysilyl-1-propylbenzenethiosulfonate; 3-triethoxysilyl-1-propyltoluenethiosulfonate; 3-triethoxysilyl-1-propylnaphthalenethiosulfonate; 3-triethoxysilyl-1-propylxylenethiosulfonate; triethoxysilylmethylmethylthiosulfate; triethoxysilylmethylmethanethiosulfonate; triethoxysilylmethylethanethiosulfonate; triethoxysilylmethylbenzenethiosulfonate; triethoxysilylmethyltoluenethiosulfonate; triethoxysilylmethylnaphthalenethiosulfonate; triethoxysilylmethylxylenethiosulfonate, and the like.

In certain embodiments of the method of the first embodiment, the at least one silane is pre-mixed with the guayule rubber prior to any mixing of the guayule rubber with the filler component. In certain such embodiments, the guayule rubber is dissolved in solvent or present in latex form when it is pre-mixed with the at least one silane. In other embodiments, the guayule rubber is present in solid form when it is pre-mixed with the at least one silane. Without being bound by theory, it is believed that pre-mixing of the guayule rubber may assist in the bonding of the silane to the bagasse particles within the guayule rubber.

### Resin

In certain embodiments of the first and second embodiments disclosed herein, the amount of guayule resin that is present in the rubber composition is limited. While generally guayule resin may be added to the rubber composition as a component of the guayule rubber that is used, it is possible that guayule resin could be added separately (as “free” resin). In preferred embodiments of the first and second embodiments, the rubber composition includes no more than 4 phr (e.g., 4, 3.5, 3, 2.5, 2, 1.5, 1, 0.5 phr or less) of guayule resin, more preferably less than 4 phr of guayule resin (e.g., 3.9, 3.5, 3, 2.5, 2, 1.5, 1, 0.5 phr or less) of guayule resin, even more preferably less than 1 phr of guayule resin (e.g., 0.9, 0.8, 0.7, 0.6, 0.5, 0.4, 0.3, 0.2, 0.1 or 0 phr) of guayule resin.

While the amount of guayule resin that is present in the rubber compositions of the first and second embodiments is preferably limited, in certain embodiments other hydrocarbon (non-guayule) resin can be utilized in the rubber composition. When a non-guayule hydrocarbon resin is used in the rubber compositions of the first and second embodiments disclosed herein, the type and amount of resin used may vary.

In those embodiments of the first and second embodiments where a non-guayule hydrocarbon resin is used, the amount present in the rubber composition is generally 5-50 phr (e.g., 5, 10, 15, 20, 25, 30, 35, 40, 45, or 50 phr). Various types of non-guayule hydrocarbon resins may be utilized, including plasticizing resins. As used herein, the term plasticizing resin refers to a compound that is solid at room temperature (23° C.) and is miscible in the rubber composition at the amount used which is usually at least 5 phr. Generally, a plasticizing resin will act as a diluting agent and can be contrasted with tackifying resins which are generally immiscible and may migrate to the surface of a rubber composition providing tack. In certain embodiments of the first and second embodiments when a non-guayule hydrocarbon resin (in the form of a plasticizing resin) is utilized, it is selected from an aliphatic type, aromatic type or aliphatic/aromatic type depending on the monomers contained therein. Examples of suitable plasticizing resins (non-guayule hydrocarbon resins) for use in the rubber compositions of the first and second embodiments include, but are not limited to, cyclopentadiene (abbreviated to CPD) or dicyclopentadiene (abbreviated to DCPD) homopolymer or copolymer resins, terpene homopolymer or copolymer resins and C5 fraction homopolymer or copolymer resins. Such resins may be used, for example, individually or in combination. In certain embodiments of the first and second embodiments, a plasticizing resin (non-guayule hydrocarbon resin) is used which meets at least one of the following: a Tg greater than 30° C. (preferably greater than 40° C. and/or no more than 120° C. or no more than 100° C.), a number average molecular weight (Mn) of between 400 and 2000 grams/mole (preferably 500-2000 grams/mole), and a polydispersity index (PI) of less than 3 (preferably less than 2), wherein PI=Mvv/Mn and Mvv is the weight-average molecular weight of the resin. Tg of the resin can be measured by DSC (Differential Scanning calorimetry) according to ASTM D3418 (1999). Mw, Mn and PI of the resin may be determined by size exclusion chromatography (SEC), using THF, 35° C.; concentration 1 g/1; flow rate 1 milliliters/min; solution filtered through a filter with a porosity of 0.45 μm before injection; Moore calibration with polystyrene standards; set of 3 “Waters” columns in series (“Styragel” HR4E, HR1 and HR0.5); detection by differential refractometer (“Waters 2410”) and its associated operating software (“Waters Empower”).

### Other (Optional) Ingredients of the Rubber Composition

According to the first and second embodiments, additional ingredients may be present in the rubber composition. These additional ingredients include, but are not limited to, liquid plasticizer, a cure package, waxes (which in some instances are antioxidants), processing aids, reinforcing resins, peptizers, and antioxidants/antidegradants. In preferred embodiments of the first and second embodiments, a cure package is included in the rubber composition.

In certain embodiments of the first and second embodiments, the rubber composition includes 1 to 30 phr of a liquid plasticizer. The phrase liquid plasticizer should be understood to refer to plasticizers that are liquid at 25° C., including, but not limited, to oils and ester plasticizers. Generally, according to the first and second embodiments, when a liquid plasticizer is used one or more than one liquid plasticizer may be utilized. The total amount of liquid plasticizer may be referred to as the amount of plasticizer component. In certain embodiments of the first and second embodiments, the rubber composition includes 1 to 30 phr of liquid plasticizer (e.g., 1, 2, 4, 6, 8, 10, 12, 14, 15, 16, 18, 20, 22, 24, 25, 26, 28, or 30 phr) or an amount falling within the foregoing range such as 1 to 20 phr or 5 to 20 phr, preferably 10 to 30 phr (e.g., 10, 12, 14, 15, 16, 18, 20, 22, 24, 25, 26, 28, or 30 phr) of liquid plasticizer or an amount falling within such as 10 to 25 phr or 10 to 20 phr. The term oil is meant to encompass both free oil (which is usually added during the compounding process) and extender oil (which is used to extend a rubber). As a non-limiting example, by stating that the rubber composition includes 20 phr of oil it should be understood that the total amount of any free oil and any extender oil is 20 phr. Similarly, by stating that the rubber composition contains 20 phr of liquid plasticizer, it should be understood that the total amount of any liquid plasticizer (including free oil, extender oil, and ester plasticizer) is 20 phr. In certain embodiments of the first and second embodiments, when the rubber composition contains oil, the only oil is free oil in one of the foregoing amounts (e.g., 1 to 30 phr, 10 to 30 phr, 5 to 20 phr, etc.). In other embodiments of the first and second embodiments, when the rubber composition contains oil, the only oil is extender oil in one of the foregoing amounts (e.g., 1 to 30 phr, 10 to 30 phr, 5 to 20 phr, etc.). In those embodiments of the first and second embodiments wherein an oil-extended rubber is used the amount of oil used to prepare the oil-extended rubber may vary; in certain such embodiments, the amount of extender oil present in the oil-extended rubber (polymer) is 10-50 parts oil per 100 parts of rubber (e.g., 10, 15, 20, 25, 30, 35, 40, 45 or 50 parts oil per 100 parts of rubber), preferably 10-40 parts oil per 100 parts of rubber or 20-40 parts oil per 100 parts of rubber. When an oil-extended rubber is used in the rubber component of the rubber composition disclosed herein, the amounts specified for the rubber(s) of the rubber component, as discussed above, should be understood to refer to the amounts of rubber only rather than the amounts of oil-extended rubber. As a non-limiting example, extender oil could be used in an amount of 40 parts oil per 100 parts rubber in an SBR used in an amount of 15 parts in the overall rubber composition and, thus, the amount of oil contributed by the oil-extended SBR to the rubber composition would be described as 6 phr.

As used herein, oil refers to both petroleum-based oils (e.g., aromatic, naphthenic, and low PCA oils) as well as plant oils (such as can be harvested from vegetables, nuts, and seeds). Plant oils will generally comprise triglycerides and the term should be understood to include synthetic triglycerides as well as those actually sourced from a plant.

According to the first and second embodiments when one or more oils are present in the rubber composition, various types of processing and extender oils may be utilized, including, but not limited to aromatic, naphthenic, and low PCA oils (petroleum-sourced or plant-sourced). Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom. Exemplary petroleum-sourced low PCA oils include mild extraction solvates (MES), treated distillate aromatic extracts (TDAE), TRAE, and heavy naphthenics. Exemplary MES oils are available commercially as CATENEX SNR from SHELL, PROREX 15, and FLEXON 683 from EXXONMOBIL, VIVATEC 200 from BP, PLAXOLENE MS from TOTAL FINA ELF, TUDALEN 4160/4225 from DAHLEKE, MES-H from REPSOL, MES from Z8, and OLIO MES S201 from AGIP. Exemplary TDAE oils are available as TYREX 20 from EXXONMOBIL, VIVATEC 500, VIVATEC 180, and ENERTHENE 1849 from BP, and EXTENSOIL 1996 from REPSOL. Exemplary heavy naphthenic oils are available as SHELLFLEX 794, ERGON BLACK OIL, ERGON H2000, CROSS C2000, CROSS C2400, and SAN JOAQUIN 2000L. Exemplary low PCA oils also include various plant-sourced oils such as can be harvested from vegetables, nuts, and seeds. Non-limiting examples include, but are not limited to, soy or soybean oil, sunflower oil (including high oleic sunflower oil), safflower oil, corn oil, linseed oil, cotton seed oil, rapeseed oil, cashew oil, sesame oil, camellia oil, jojoba oil, hemp oil, macadamia nut oil, coconut oil, and palm oil. The foregoing processing oils can be used as an extender oil, i.e., to prepare an oil-extended polymer or copolymer or as a processing or free oil.

In those embodiments of the first and second embodiments wherein one or more oils are present in the rubber composition, the Tg of the oil or oils used may vary. In certain embodiments of the first and second embodiments, any oil utilized has a Tg of about −40 to about −100° C., −40 to −100° C. (e.g., −40, −45, −50, −55, −60, −65, −70, −75, −80, −85, −90, −95, or −100° C.), about −40 to about −90° C., −40 to −90° C. (e.g., −40, −45, −50, −55, −60, −65, −70, −75, −80, −85, or −90° C.), about −45 to about −85° C., −45 to −85° C. (e.g., −45, −50, −55, −60, −65, −70, −75, −80, or −85° C.), about −50 to about −80° C., or −50 to −80° C. (e.g., −50, −55, −60, −65, −70, −75, or −80° C.).

In certain embodiments of the first and second embodiments, the rubber composition contains less than 5 phr (e.g., 4.5, 4, 3, 2, 1, or 0 phr) of MES or TDAE oil, preferably no MES or TDAE oil (i.e., 0 phr). In certain embodiments of the first and second embodiments, the rubber composition contains no petroleum oil (i.e., 0 phr) and instead any oil utilized is a plant oil. In certain embodiments of the first and second embodiments, the rubber composition contains soybean oil in one of the above-mentioned amounts; in certain such embodiments the only oil included is soybean oil. In certain embodiments of the first and second embodiments, the rubber composition contains no sunflower oil (i.e., 0 phr). In other embodiments of the first and second embodiments, the only oil included is sunflower oil.

In certain embodiments of the first and second embodiments, the rubber composition includes one or more ester plasticizers, which is a type of plasticizer that is generally liquid at room temperature. Suitable ester plasticizers are known to those of skill in the art and include, but are not limited to, phosphate esters, phthalate esters, adipate esters and oleate esters (i.e., derived from oleic acid). Taking into account that an ester is a chemical compound derived from an acid wherein at least one-OH is replaced with an —O-alkyl group, various alkyl groups may be used in suitable ester plasticizers for use in the tread rubber compositions, including generally linear or branched alkyl of C₁ to C₂₀ (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀), or C₆ to C₁₂. Certain of the foregoing esters are based upon acids which have more than one-OH group and, thus, can accommodate one or more than one O-alkyl group (e.g., trialkyl phosphates, dialkyl phthalates, dialkyl adipates). Non-limiting examples of suitable ester plasticizers include trioctyl phosphate, dioctyl phthalate, dioctyl adipate, nonyl oleate, octyl oleate, and combinations thereof. The use of an ester plasticizer such as one or more of the foregoing may be beneficial to the snow or ice performance of a tire made from a tread rubber composition containing such ester plasticizer at least in part due to the relatively low Tg of ester plasticizers. In certain embodiments of the first and second embodiments, the tread rubber composition includes one or more ester plasticizers having a Tg of −40° C. to −70° C. (e.g., −40, −45, −50, −55, −60, −65, or −70° C.), or −50° C. to −65° C. (e.g., −50, −51, −52, −53, −54, −55, −56, −57, −58, −59, −60, −61, −62, −63, −64, or −65° C.). In those embodiments of the first and second embodiments wherein one or more ester plasticizers is utilized the amount utilized may vary. In certain embodiments of the first and second embodiments, one or more ester plasticizers are utilized in a total amount of 1-25 phr (e.g., 1, 2, 3, 4, 5, 6, 7, 8, 9, 10, 11, 12, 13, 14, 15, 16, 17, 18, 19, 20, 21, 22, 23, 24, or 25 phr), 1-20 phr (e.g., 1, 2, 3, 4, 5, 6, 7, 8, 9, 10, 11, 12, 13, 14, 15, 16, 17, 18, 19, or 20 phr), 1-15 phr (e.g., 1, 2, 3, 4, 5, 6, 7, 8, 9, 10, 11, 12, 13, 14, or 15 phr), 1-10, phr (e.g., 1, 2, 3, 4, 5, 6, 7, 8, 9, or 10 phr), 2-6 phr (e.g., 2, 3, 4, 5, or 6 phr) or 2-5 phr (e.g., 2, 3, 4, or 5 phr). In certain preferred embodiments of the first and second embodiments, the amount of any ester plasticizer is no more than 15 phr or no more than 12 phr. In certain embodiments of the first and second embodiments, one or more ester plasticizers are used (in one of the foregoing amounts) in combination with oil where the oil is present in an amount of 1 to less than 10 phr, or 1-5 phr. In other embodiments of the first and second embodiments, one or more ester plasticizers is used without any oil being present in the tread rubber composition (i.e., 0 phr of oil).

As discussed above, in certain embodiments of the first and second embodiments disclosed herein, the rubber composition includes (comprises) a cure package. Although the contents of the cure package may vary, generally, the cure package includes at least one of: a vulcanizing agent; a vulcanizing accelerator; a vulcanizing activator (e.g., zinc oxide, stearic acid, and the like); a vulcanizing inhibitor; and an anti-scorching agent. In certain embodiments of the first and second embodiments, the cure package includes at least one vulcanizing agent, at least one vulcanizing accelerator, at least one vulcanizing activator and optionally a vulcanizing inhibitor and/or an anti-scorching agent. Vulcanizing accelerators and vulcanizing activators act as catalysts for the vulcanization agent. Various vulcanizing inhibitors and anti-scorching agents are known in the art and can be selected by one skilled in the art based on the vulcanizate properties desired.

Examples of suitable types of vulcanizing agents for use in certain embodiments of the first and second embodiments, include but are not limited to, sulfur or peroxide-based curing components. Thus, in certain such embodiments, the cure package includes a sulfur-based curative or a peroxide-based curative. In preferred embodiments of the first and second embodiments, the vulcanizing agent is a sulfur-based curative; in certain such embodiments the vulcanizing agent consists of (only) a sulfur-based curative. Examples of specific suitable sulfur vulcanizing agents include “rubbermaker's” soluble sulfur; sulfur donating curing agents, such as an amine disulfide, polymeric polysulfide, or sulfur olefin adducts; and insoluble polymeric sulfur. Preferably, the sulfur vulcanizing agent is soluble sulfur or a mixture of soluble and insoluble polymeric sulfur. For a general disclosure of suitable vulcanizing agents and other components used in curing, e.g., vulcanizing inhibitor and anti-scorching agents, one can refer to Kirk-Othmer, Encyclopedia of Chemical Technology, 3rd ed., Wiley Interscience, N.Y. 1982, Vol. 20, pp. 365 to 468, particularly Vulcanization Agents and Auxiliary Materials, pp. 390 to 402, or Vulcanization by A. Y. Coran, Encyclopedia of Polymer Science and Engineering, Second Edition (1989 John Wiley & Sons, Inc.), both of which are incorporated herein by reference. Vulcanizing agents can be used alone or in combination. Generally, the vulcanizing agents may be used in certain embodiments of the first and second embodiments in an amount ranging from 0.1 to 10 phr (e.g., 0.1, 0.5, 1, 2, 3, 4, 5, 6, 7, 8, 9, or 10 phr), including from 1 to 7.5 phr, including from 1 to 5 phr, and preferably from 1 to 3.5 phr (e.g., 1, 1.5, 2, 2.5, 3, or 3.5 phr).

Vulcanizing accelerators are used to control the time and/or temperature required for vulcanization and to improve properties of the vulcanizate. Examples of suitable vulcanizing accelerators for use in certain embodiments of the first and second embodiments disclosed herein include, but are not limited to, thiazole vulcanization accelerators, such as 2-mercaptobenzothiazole, 2,2′-dithiobis(benzothiazole) (MBTS), N-cyclohexyl-2-benzothiazole-sulfenamide (CBS), N-tert-butyl-2-benzothiazole-sulfenamide (TBBS), and the like; guanidine vulcanization accelerators, such as diphenyl guanidine (DPG) and the like; thiuram vulcanizing accelerators; carbamate vulcanizing accelerators; and the like. Generally, the amount of the vulcanization accelerator used ranges from 0.1 to 10 phr (e.g., 0.1, 0.5, 1, 2, 3, 4, 5, 6, 7, 8, 9, or 10 phr), preferably 0.5 to 5 phr (e.g., 0.5, 1, 1.5, 2, 2.5, 3, 3.5, 4, 4.5, or 5 phr). Preferably, any vulcanization accelerator used in the rubber compositions of the first and second embodiments excludes any thiurams such as thiuram monosulfides and thiuram polysulfides (examples of which include TMTM (tetramethyl thiuram monosulfide), TMTD (tetramethyl thiuram disulfide), DPTT (dipentamethylene thiuram tetrasulfide), TETD (tetraethyl thiuram disulfide), TiBTD (tetraisobutyl thiuram disulfide), and TBzTD (tetrabenzyl thiuram disulfide)); in other words, the rubber compositions of the first and second embodiments preferably contain no thiuram accelerators (i.e., 0 phr).

Vulcanizing activators are additives used to support vulcanization. Generally vulcanizing activators include both an inorganic and organic component. Zinc oxide is the most widely used inorganic vulcanization activator. Various organic vulcanization activators are commonly used including stearic acid, palmitic acid, lauric acid, and zinc salts of each of the foregoing. Generally, in certain embodiments of the first and second embodiments the amount of vulcanization activator used ranges from 0.1 to 6 phr (e.g., 0.1, 0.5, 1, 1.5, 2, 2.5, 3, 3.5, 4, 4.5, 5, 5.5, or 6 phr), preferably 0.5 to 4 phr (e.g., 0.5, 1, 1.5, 2, 2.5, 3 3.5, or 4 phr). In certain embodiments of the first and second embodiments, both zinc oxide and stearic acid are used as vulcanizing activators with the total amount utilized falling within one of the foregoing ranges; in certain such embodiments, the only vulcanizing activators used are zinc oxide and stearic acid. In certain embodiments of the first and second embodiments, one or more vulcanization activators are used which includes one or more thiourea compounds (used in the of the foregoing amounts), and optionally in combination with one or more of the foregoing vulcanization activators. Generally, a thiourea compound can be understood as a compound having the structure (R¹)(R²)NS(═C)N(R³)(R⁴) wherein each of R¹, R², R³, and R⁴ are independently selected from H, alkyl, aryl, and N-containing substituents (e.g., guanyl). Optionally, two of the foregoing structures can be bonded together through N (removing one of the R groups) in a dithiobiurea compound. In certain embodiments, one of R¹ or R² and one of R³ or R⁴ can be bonded together with one or more methylene groups (—CH₂—) therebetween. In certain embodiments of the first and second embodiments, the thiourea has one or two of R¹, R², R³ and R⁴ selected from one of the foregoing groups with the remaining R groups being hydrogen. Exemplary alkyls include C1-C6 linear, branched or cyclic groups such as methyl, ethyl, propyl, iso-propyl, butyl, iso-butyl, pentyl, hexyl, and cyclohexyl. Exemplary aryls include C6-C12 aromatic groups such as phenyl, tolyl, and naphthyl. Exemplary thiourea compounds include, but are not limited to, dihydrocarbylthioureas such as dialkylthioureas and diarylthioureas. Non-limiting examples of particular thiourea compounds include one or more of thiourea, N,N′-diphenylthiourea, trimethylthiourea, N,N′-diethylthiourea (DEU), N,N′-dimethylthiourea, N,N′-dibutylthiourea, ethylenethiourea, N,N′-diisopropylthiourea, N,N′-dicyclohexylthiourea, 1,3-di(o-tolyl) thiourea, 1,3-di(p-tolyl) thiourea, 1,1-diphenyl-2-thiourea, 2,5-dithiobiurea, guanylthiourea, 1-(1-naphthyl)-2-thiourea, 1-phenyl-2-thiourea, p-tolylthiourea, and o-tolylthiourea. In certain embodiments of the first and second embodiments, the activator includes at least one thiourea compound selected from thiourea, N,N′-diethylthiourea, trimethylthiourea, N,N′-diphenylthiourea, and N—N′-dimethylthiourea.

Vulcanization inhibitors are used to control the vulcanization process and generally retard or inhibit vulcanization until the desired time and/or temperature is reached. Common vulcanization inhibitors include, but are not limited to, PVI (cyclohexylthiophthalmide) from Santogard. Generally, in certain embodiments of the first and second embodiments the amount of vulcanization inhibitor is 0.1 to 3 phr (e.g., 0.1, 0.5, 1, 1.5, 2, 2.5, or 3 phr), preferably 0.5 to 2 phr (e.g., 0.5, 1, 1.5, or 2 phr).

Various other ingredients that may optionally be added to the rubber compositions of the first and second embodiment as disclosed herein include waxes (which in some instances are antioxidants), processing aids, reinforcing resins, peptizers, and antioxidants/antidegradants. Ingredients which are antidegradants may also be classified as an antiozonant or antioxidant, such as those selected from: N,N′disubstituted-p-phenylenediamines, such as N-1,3-dimethylbutyl-N′phenyl-p-phenylenediamine (6PPD), N,N′-Bis(1,4-dimethylpently)-p-phenylenediamine (77PD), N-phenyl-N-isopropyl-p-phenylenediamine (IPPD), and N-phenyl-N′-(1,3-dimethylbutyl)-p-phenylenediamine (HPPD). Other examples of antidegradants include, acetone diphenylamine condensation product, 2,4-Trimethyl-1,2-dihydroquinoline, Octylated Diphenylamine, 2,6-di-t-butyl-4-methyl phenol and certain waxes. In certain other embodiments of the first and second embodiments, the composition may be free or essentially free of antidegradants such as antioxidants or antiozonants.

### Methods for Improving Rolling Resistance

As mentioned above, the first embodiment disclosed herein is directed to a method for improving the rolling resistance of the rubber composition. The improvement in rolling resistance is as compared to a control rubber composition which contains the same ingredients except for lacking any silica and silane. It should be understood that the tire rubber compositions according to the second embodiment disclosed herein will also exhibit an improvement in rolling resistance (as compared to a control rubber composition which contains the same ingredients except for lacking any silica and silane).

According to the first and second embodiments disclosed herein, the amount of improvement in rolling resistance that is achieved from use of the at least one silane in combination with the bagasse-containing guayule rubber may vary. The improvement in rolling resistance can be measured by various methods including, but not limited to, the method provided in the working Examples. In certain embodiments of the first and second embodiments, the improvement in rolling resistance is at least 3% (e.g., 3%, 4%, 5%, 6%, 7%, 8%, 9%, 10%, 11%, 12%, 13%, 14%, 15%, 16%, 17%, 18%, 19%, 20%, 25%, or more) or 3-20% (e.g., 3%, 4%, 5%, 6%, 7%, 8%, 9%, 10%, 11%, 12%, 13%, 14%, 15%, 16%, 17%, 18%, 19%, or 20%) as compared to a control rubber composition which contains the same ingredients except for lacking any silica and silane. In preferred embodiments of the first and second embodiments, the improvement in rolling resistance is at least 5% (e.g., 5%, 6%, 7%, 8%, 9%, 10%, 11%, 12%, 13%, 14%, 15%, 16%, 17%, 18%, 19%, 20%, 25% or more) or 5-20% (e.g., 5%, 6%, 7%, 8%, 9%, 10%, 11%, 12%, 13%, 14%, 15%, 16%, 17%, 18%, 19%, or 20%), more preferably at least 10% (e.g., 10%, 11%, 12%, 13%, 14%, 15%, 16%, 17%, 18%, 19%, 20%, 25% or more) or 10-20% (e.g., 10%, 11%, 12%, 13%, 14%, 15%, 16%, 17%, 18%, 19%, or 20%), or even at least 15% (e.g., 15%, 16%, 17%, 18%, 19%, 20%, 25% or more) or 15-20% (e.g., 15%, 16%, 17%, 18%, 19%, or 20%) as compared to a control rubber composition which contains the same ingredients except for lacking any silica and silane.

In certain embodiments of the first and second embodiments, the improvement in rolling resistance is combined with an improvement in M300. According to such embodiments, the amount of improvement in M300 can vary. In certain embodiments of the first and second embodiments, the improvement in M300 is at least 3% (e.g., 3%, 4%, 5%, 6%, 7%, 8%, 9%, 10%, 11%, 12%, 13%, 14%, 15%, or more) or 3-10% (e.g., 3%, 4%, 5%, 6%, 7%, 8%, 9%, or 10%) as compared to a control rubber composition which contains the same ingredients except for lacking any silica and silane. In preferred embodiments of the first and second embodiments, the improvement in M300 is at least 5% (e.g., 5%, 6%, 7%, 8%, 9%, 10%, 11%, 12%, 13%, 14%, 15%, or more) or 5-10% (e.g., 5%, 6%, 7%, 8%, 9%, or 10%) as compared to a control rubber composition which contains the same ingredients except for lacking any silica and silane

### Tires

A rubber composition according to the first embodiment (or a rubber composition as produced according to the method of the first embodiment) can be used to prepare a tire having at least one component comprised of the rubber composition, wherein the component is selected from a tire tread, tire sidewall, tire belt skim, or tire carcass. In preferred embodiments, the component is a tire tread. Also disclosed herein is a heavy duty or commercial truck or bus tire having a tread made from a rubber composition according to the first embodiment (or a rubber composition as produced according to the method of the first embodiment).

### WORKING EXAMPLES

The following examples illustrate specific and exemplary embodiments and/or features of the embodiments of the present disclosure. The examples are provided solely for the purposes of illustration and should not be construed as limitations of the present disclosure. Numerous variations over these specific examples are possible without departing from the spirit and scope of the presently disclosed embodiments. It should specifically be understood that rubber compositions can be prepared using different amounts of guayule rubber (containing different amounts of bagasse), as discussed above); using different amounts or types of silanes, as discussed above; or using different amounts or types of fillers, as discussed above. It should also be understood that the guayule rubber which includes a bagasse component and silane can be utilized in rubber compositions along with ingredients (e.g., additional rubber(s), fillers, cure package ingredients) that differ in relative amount, composition, or both from those used in the examples (i.e., as fully as disclosed in the preceding paragraphs).

Examples 1-6: Rubber compositions were prepared using one of two types of guayule rubber (containing different amounts of bagasse). As indicated below in Table 1, some rubber compositions contained silica with no silane (Examples 1 and 4), other rubber compositions contained both silica and silane (examples 3 and 5), and other rubber compositions contained silane but no silica (Examples 2 and 6). Examples 2 and 6 can be considered inventive examples with the other examples presented for purposes of comparison. The overall rubber composition used was a tread rubber composition and the relative amounts of rubber, carbon black filler, silica filler, silane and resin are indicated in Table 1 (amounts are provided in phr or amount per 100 parts of rubber), with other ingredients remaining the same in all of Examples 1-6. Notably, the amount of guayule rubber-2 is listed as 110 parts or phr (which indicates the presence of 100 parts of rubber and 10 parts of bagasse).

TABLE 1

| | Example 1 | Example 2 | Example 3 | Example 4 | Example 5 | Example 6 |
|---|---|---|---|---|---|---|
| | (Stock 4-1) | (Stock 9-1) | (Stock 10-1) | (Stock 6-1) | (Stock 7-1) | (Stock 8-1) |
| Guayule | 100 | 100 | 100 | 0 | 0 | 0 |
| rubber-1 | | | | | | |
| (AA7614/GR2.2) | | | | | | |
| Guayule | 0 | 0 | 0 | 110 | 110 | 110 |
| rubber-2 | | | | | | |
| (AA7627) | | | | | | |
| Carbon black | 43 | 43 | 43 | 43 | 43 | 43 |
| Silica | 6 | 0 | 6 | 6 | 6 | 0 |
| Silane | 0 | 0.2 | 0.8 | 0 | 0.8 | 0.8 |
| Resin | 2 | 2 | 2 | 2 | 2 | 2 |

Guayule rubber-1: contains less than 1% by weight bagasse, about 2% by weight resin, and has Mn 200,000 grams/mole and Mw 1 million grams/mole
Guayule rubber-2: contains about 10% by weight bagasse, about 4% by weight resin, and has Mn 200,000 grams/mole and Mw 1 million grams/mole
Silane: bis[3-(triethoxysilyl)-propyl]disulfide
Resin: hydrocarbon resin (non-guayule) Tg of 35-45° C.

The ingredients for each of the Examples were mixed in a Brabender mixer using the procedure set forth in Table 2 below. The resulting rubber compositions were cured at 145° C. for 15 minutes.

For each of the rubber compositions of Examples 1-6, the properties listed in Table 3 were determined as follows. Tan δ values were measured using a strain sweep test conducted with an Advanced Rheometric Expansion System (ARES) from TA Instruments. The test specimen had a cylindrical geometry having a length of 14.4 mm and a diameter of 7.8 mm. The test was conducted using a frequency of 10 rad/sec. The strain was swept from 0.1% to 16% and the temperature was started at 22° C. and increased to 60° C. and held at 60° C. The measurement at 60° C. and 10% strain is listed in Table 3 for each of the rubber compositions. A rubber composition's tan δ at 60° C. is indicative of its rolling resistance when incorporated into a tire tread. The tan δ values are presented as indexed numbers (calculated by comparing the value for a given example as compared to the value for the relative control rubber composition) wherein a number above 100 is considered to be an improvement. Since a lower tan δ value at 60° C. is considered to be an improvement, the indexed values were calculated as (control/value)×100. Example 1 is used as a control for Examples 2 and 3 and Example 4 is used as a control for Examples 5 and 6.

Tensile mechanical properties of the samples were determined following the guidelines, but not restricted to, the standard procedure described in ASTM D-412, using dumbbell-shaped samples with a cross-section dimension of 4 mm in width and 1.9 mm in thickness at the center. Specimens were strained at a constant rate and the resulting force was recorded as a function of extension (strain). Samples were cured for 40 minutes at 150° C., and then tensile properties were analyzed at 25° C. The abbreviation M300 is used for the tensile stress measured at 300% elongation. The M300 values are presented as indexed numbers (calculated by comparing the value for a given example as compared to the value for the relative control rubber composition) wherein a number above 100 is considered to be an improvement. Since a higher M300 value is considered to be an improvement, the indexed values were calculated as (value/control)×100. Example 1 is used as a control for Examples 2 and 3 and Example 4 is used as a control for Examples 5 and 6.

TABLE 2
Mixing Parameters

| | | |
|---|---|---|
| Master-Batch Stage | 0 seconds | Charge polymers |
| (initial temp: 130° C., | | |
| rotor rpm started at 60) | | |
| | 30 to 150 | Charge any oil, carbon black filler |
| | seconds | and other master-batch ingredients, |
| | | increase rotor speed to 90 rpm |
| | | Drop based on max temperature |
| | | of 165° C. or 4.5 minutes |
| | | mixing (whichever comes first) |
| Final Batch Stage | 0 seconds | Charge master-batch |
| (initial temp: 65-70° C., | | |
| rotor rpm at 45) | | |
| | 0 seconds | Charge curatives (sulfur, |
| | | accelerators and activators) |
| | | Drop based on max temperature |
| | | of 100° C. or 2.5 minutes |
| | | mixing (whichever comes first) |

TABLE 3

| | Example 1 | Example 2 | Example 3 | Example 4 | Example 5 | Example 6 |
|---|---|---|---|---|---|---|
| | (Stock 4-1) | (Stock 9-1) | (Stock 10-1) | (Stock 6-1) | (Stock 7-1) | (Stock 8-1) |
| Indexed Tan δ | 100 | 115.1 | 103.1 | 100 | 102.1 | 115.4 |
| 60° C. (10% | | | | | | |
| strain, 10 Hz) | | | | | | |
| Indexed M300 | 100 | 103.8 | 104.3 | 100 | 104.5 | 104.0 |
| (room temperature) | | | | | | |

As can be seen from the data of Table 3, of Examples 1-3, inventive Example 2 (which contained silane but no silica) has the best tan δ at 60° C., indicating the rubber composition would exhibit the lowest (best) rolling resistance when utilized in a tire tread. Of Examples 4-6, inventive Example 6 (which contained silane but no silica) also has the best tan δ at 60° C., indicating the rubber composition would exhibit the lowest (best) rolling resistance when utilized in a tire tread.

Examples 7-10: Rubber compositions were prepared using a third type of guayule rubber (guayule rubber-3) at 90 phr in combination with 10 phr of high-cis polybutadiene (having a cis 1,4-bond content of 96% and a Tg of −108° C.). Ingredients are indicated below in Table 4. Examples 8 and 9 (which contain silane but no silica) can be considered inventive examples with the other examples presented for purposes of comparison. The overall rubber composition used was a tread rubber composition (although somewhat different than the base tread rubber composition from Examples 1-6) and the relative amounts of rubber, carbon black filler, silica filler, silane and resin are indicated in Table 4 (amounts are provided in phr or amount per 100 parts of rubber), with other (non-listed) ingredients remaining the same in all of Example 7-10.

TABLE 4

| | Example 7 | Example 8 | Example 9 | Example 10 |
|---|---|---|---|---|
| | (Stock 6) | (Stock 7) | (Stock 8) | (Stock 9) |
| Guayule | 90 | 90 | 90 | 90 |
| rubber-3 | | | | |
| (GR2.2) | | | | |
| Polybutadiene | 10 | 10 | 10 | 10 |
| Carbon black | 59 | 59 | 59 | 59 |
| Silica | 0 | 0 | 0 | 0 |
| Silane | 0 | 0.2 | 0.4 | 0.4 |
| Resin | 0 | 0 | 0 | 2 |

Guayule rubber-3: contains about 1% by weight bagasse, less than about 2% by weight resin (i.e., less than amount of resin in guayule rubber-1), and has Mn 300,000 grams/mole and Mw 1.3 million grams/mole
Silane: bis[3-(triethoxysilyl)-propyl]disulfide
Resin: guayule resin (polar fraction)

The ingredients for each of Examples 7-10 were mixed in a Brabender mixer using the procedure set forth in Table 2 above. The resulting rubber compositions were cured at 160° C. for 12 minutes.

For each of the rubber compositions of Examples 7-10, the properties listed in Table 5 were determined using the procedures described above for Examples 1-6. Indexed values are calculated as described above, with Example 7 being considered to be a control for each of Examples 8-10.

TABLE 5

| | Example 7 | Example 8 | Example 9 | Example 10 |
|---|---|---|---|---|
| | (Stock 6) | (Stock 7) | (Stock 8) | (Stock 9) |
| Indexed tan δ 60° C. | 100 | 103.1 | 99.6 | 92.2 |
| (10% strain, 10 Hz) | | | | |
| M300 (room | 100 | 105.2 | 110.2 | 96.2 |
| temperature) | | | | |

As can be seen from the data of Table 5, of Examples 7-10, the best tan δ at 60° C. is for inventive Example 8, indicating this rubber composition would exhibit the lowest (best) rolling resistance when utilized in a tire tread. Inventive Example 9 has a tan δ at 60° C. that is only slightly worse than that of comparative Example 7, indicating that the rolling resistance would be essentially the same in the two. Notably, inventive Example 9 has a M300 that is considerably higher (i.e., improved) as compared to comparative Example 7, indicating that overall inventive Example 9 has better properties than comparative Example 7.

Examples 11-13: Rubber compositions were prepared using guayule rubber-1 at 90 phr in combination with 10 phr of high-cis polybutadiene. Ingredients are indicated below in Table 6. The silane utilized is the same as in Examples 1-10. Examples 11 and 12 (which contain silane but no silica) can be considered inventive examples with the other examples presented for purposes of comparison. The overall rubber composition used was a tread rubber composition (with the same base tread rubber composition from Examples 7-10) and the relative amounts of rubber, carbon black filler, silica filler, silane and resin are indicated in Table 6 (amounts are provided in phr or amount per 100 parts of rubber), with other (non-listed) ingredients remaining the same in all of Example 11-13.

TABLE 6

| | Example 11 | Example 12 | Example 13 |
|---|---|---|---|
| | (Stock 10) | (Stock 11) | (Stock 12) |
| Guayule rubber-1 | 90 | 90 | 90 |
| (AA7614/GR2.1) | | | |
| Polybutadiene | 10 | 10 | 10 |
| Carbon black | 59 | 59 | 59 |
| Silica | 0 | 0 | 0 |
| Silane | 0.4 | 0.8 | 0 |
| Resin | 0 | 0 | 0 |

The ingredients for each of Examples 11-13 were mixed in a Brabender mixer using the same procedure set forth in Table 2 above. The resulting rubber compositions were cured at 160° C. for 12 minutes.

For each of the rubber compositions of Examples 11-13, the properties listed in Table 7 were determined using the procedures described above for Examples 1-6. Indexed values are calculated as discussed above with Example 13 considered a control for Examples 11 and 12.

TABLE 7

| | Example 11 | Example 12 | Example 13 |
|---|---|---|---|
| | (Stock 10) | (Stock 11) | (Stock 12) |
| Indexed Tan δ 60° C. | 102.7 | 104.6 | 100 |
| (10% strain, 10 Hz) | | | |
| M300 (room | 100.9 | 101.4 | 100 |
| temperature) | | | |

As can be seen from the data of Table 7, of Examples 11-13, both of the inventive examples (Examples 11 and 12) have a better tan δ at 60° C. than comparative Example 13, indicating these rubber compositions would exhibit lower (better) rolling resistance when utilized in a tire tread. Both of the inventive Examples also have a better (higher) M300 as compared to comparative Example 13.

Examples 14-18: Rubber compositions were prepared using natural rubber instead of guayule rubber. Natural rubber (harvested from the Hevea tree) does not contain any bagasse. Ingredients are indicated below in Table 8. The silane used is the same as in Examples 1-13. None of these Examples are considered to be inventive. The overall rubber composition used was a tread rubber composition (with the same base tread rubber composition from Examples 7-13) and the relative amounts of rubber, carbon black filler, silica filler, silane and resin are indicated in Table 8 (amounts are provided in phr or amount per 100 parts of rubber), with other (non-listed) ingredients remaining the same in all of Example 14-18. The resin used in Examples 15 and 18 was a guayule resin (polar fraction).

TABLE 8

| | Ex- | Ex- | Ex- | Ex- | Ex- |
|---|---|---|---|---|---|
| | ample | ample | ample | ample | ample |
| | 14 | 15 | 16 | 17 | 18 |
| | (Stock | (Stock | (Stock | (Stock | (Stock |
| | 1) | 2) | 3) | 4) | 5) |
| Natural | 90 | 90 | 90 | 90 | 90 |
| rubber | | | | | |
| Polybutadiene | 10 | 10 | 10 | 10 | 10 |
| Carbon black | 59 | 59 | 59 | 59 | 59 |
| Silica | 0 | 0 | 0 | 0 | 0 |
| Silane | 0 | 0.4 | 0.2 | 0.4 | 0.4 |
| Resin | 0 | 2 | 0 | 0 | 2 |

The ingredients for each of the Examples were mixed in a Brabender mixer using the same procedure set forth in Table 2 above. The resulting rubber compositions were cured at 160° C. for 12 minutes.

For each of the rubber compositions of Examples 14-18 the properties listed in Table 9 were determined using the procedures described above for Examples 1-6. Indexed values are calculated are described above with Example 14 considered a control for each of Examples 15-18.

TABLE 9

| | Ex- | Ex- | Ex- | Ex- | Ex- |
|---|---|---|---|---|---|
| | ample | ample | ample | ample | ample |
| | 14 | 15 | 16 | 17 | 18 |
| | (Stock | (Stock | (Stock | (Stock | (Stock |
| | 1) | 2) | 3) | 4) | 5) |
| Indexed tan δ | 100 | 85.3 | 92.1 | 92.9 | 84.3 |
| 60° C. | | | | | |
| (10% strain, | | | | | |
| 10 Hz) | | | | | |
| Indexed M300 | 100 | 85.6 | 99.2 | 103.1 | 91.6 |
| (room | | | | | |
| temperature) | | | | | |

As can be seen from the data of Table 9, within Examples 14-18, the rubber composition having the best (lowest) tan δ at 60° C. is Example 14 which contains no silica, no silane and no resin. In other words, the rubber compositions of Examples 16 and 17 which contain silane in the absence of silica and resin do not exhibit a better tan δ at 60° C. than Example 14. This data using natural rubber (instead of bagasse-containing guayule rubber) shows that the effect of using silane in the absence of silica (i.e., improvement in tan δ at 60° C.) is not present, supporting the conclusion that a reaction occurs between the bagasse in the guayule rubber and silane (in the absence of silica). Similarly, the rubber compositions of Example 15 and 18 which contain silane in the absence of silica but also include 2 phr of guayule resin also do not exhibit a better tan δ at 60° C. than Example 14, supporting the conclusion that the rolling resistance improvement is from bagasse-silane interaction rather than guayule resin-silane interaction.

This application discloses several numerical range limitations that support any range within the disclosed numerical ranges, even though a precise range limitation is not stated verbatim in the specification, because the embodiments of the compositions and methods disclosed herein could be practiced throughout the disclosed numerical ranges. With respect to the use of substantially any plural or singular terms herein, those having skill in the art can translate from the plural to the singular or from the singular to the plural as is appropriate to the context or application. The various singular or plural permutations may be expressly set forth herein for sake of clarity.

It will be understood by those within the art that, in general, terms used herein, and especially in the appended claims are generally intended as “open” terms. For example, the term “including” should be interpreted as “including but not limited to,” the term “having” should be interpreted as “having at least,” the term “includes” should be interpreted as “includes but is not limited to.” It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” All references, including but not limited to patents, patent applications, and non-patent literature are hereby incorporated by reference herein in their entirety. While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

What is claimed is:

1. A method for preparing a tire rubber composition comprising mixing:
a. 100 parts of a rubber component including more than 50% by weight of guayule rubber where the guayule rubber includes a bagasse component in an amount of 1-20% by weight based upon the weight of the guayule rubber,
b. a filler component including carbon black in an amount of 30 to 100 phr, where the filler component is free of silica, and
c. at least one silane selected from the group consisting of mercaptosilanes, blocked mercaptosilanes and alkoxysilanes, where the at least one silane is present in a total amount of 5-20% by weight based upon the amount of bagasse component.

2. The method of claim 1, wherein the filler component contains no non-carbon black non-reinforcing filler.

3. The method of claim 1, wherein the bagasse component of the guayule rubber is present in an amount of 10-20% % by weight based upon the weight of the guayule rubber.

4. The method of claim 1, wherein the at least one silane is a sulfur-containing alkoxysilane.

5. The method of claim 1, wherein the sulfur-containing alkoxysilane is a disulfide alkoxysilane or tetrasulfide alkoxysilane.

6. The method of claim 1, wherein the sulfur-containing alkoxysilane is a disulfide alkoxysilane compound selected from the group consisting of 3,3′-bis(triethoxysilylpropyl) disulfide, 3,3′-bis(trimethoxysilylpropyl) disulfide, 3,3′-bis(tributoxysilyl-propyl) disulfide, 3,3′-bis(tri-m-butoxysilyl-propyl) disulfide, 3,3′-bis tripropoxypropyl) disulfide, 3,3′-bis(trihexoxysilylpropyl) disulfide, 2,2′-bis(dimethylmethoxysilylethyl) disulfide, 3,3′-bis(diphenylcyclohexoxysilylpropyl) disulfide, 3,3′-bis(ethyl-di-sec-butoxysilylpropyl) disulfide, 3,3′-bis(propyldiethoxysilylpropyl) disulfide, 3,3′-bis(triisopropoxysilylpropyl) disulfide, 12, 12′-bis(triisopropoxysilylpropyl) disulfide, 3,3′-bis(dimethoxyphenylsilyl-2-methylpropyl) disulfide, and combinations thereof.

7. The method of claim 1, wherein the at least one silane is a non-sulfur containing alkoxysilane selected from
(a) non-sulfur containing alkoxysilanes having formula (I): 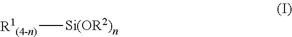
where n=2, 3, or 4; each R¹ is independently selected from hydrocarbyl groups having 1-24 carbons, preferably alkyl or cycloalkyl groups having 3-18 carbons or aryl groups having 6 to 18 carbons; and R² is an alkyl group having 1-10 carbons, preferably 1-6 carbons, more preferably 1-3 carbons, or
(b) non-sulfur containing bis-alkoxysilanes having 4 to 6 alkoxygroups.

8. The method of claim 1, wherein the at least one silane is a mercaptosilane.

9. The method of claim 1, wherein the at least one silane is a blocked mercaptosilane.

10. The method of claim 1, wherein the at least one silane is present in a total amount of 0.1 to 5 phr.

11. The method of claim 1, wherein the at least one silane is present in a total amount of 10-15% by weight based upon the amount of bagasse present in the rubber composition.

12. The method of claim 1, wherein the filler component includes a majority by weight of reinforcing carbon black.

13. The method of claim 5, wherein the bagasse component is present in an amount of 10-15% by weight based upon the weight of the guayule rubber.

14. The method of claim 1, wherein the guayule rubber of (a) and the at least one silane of (b) are pre-mixed prior to any mixing of the filler component of (c).

15. The method of claim 1, wherein the rubber component includes a minority by weight of at least one rubber selected from the group consisting of non-guayule natural rubber, polyisoprene, polybutadiene having a cis-1,4-bond content of at least 90%, functionalized polybutadiene having a cis-1,4-bond content of at least 90%, styrene-butadiene rubber, and functionalized styrene-butadiene rubber.

16. The method of claim 11, wherein the rubber composition includes less than 4 phr of resin.

17. The method of claim 1, wherein the rubber composition includes less than 1 phr of resin.

18. The method of claim 1, further comprising producing a tire having at least one component comprising the tire rubber composition of claim 18 wherein the component is selected from a tire tread, tire sidewall, tire belt skim, or tire carcass.

19. A method for preparing a tire rubber composition comprising mixing:
a. 100 parts of a rubber component including more than 50% by weight of guayule rubber where the guayule rubber includes a bagasse component in an amount of 10-20% by weight based upon the weight of the guayule rubber,
b. a filler component including carbon black in an amount of 30 to 100 phr, where the filler component is free of silica and where the filler component contains no non-carbon black non-reinforcing filler, and
c. at least one silane selected from the group consisting of mercaptosilanes, blocked mercaptosilanes and sulfur-containing alkoxysilanes, where the at least one silane is present in a total amount of 5-20% by weight based upon the amount of bagasse component.

20. The method of claim 19, wherein the guayule rubber of (a) and the at least one silane of (b) are pre-mixed prior to any mixing of the filler component of (c).
